(19) United States
(12) Patent Application Publication
(10) Pub. No.: US 2018/0173708 A1
(43) Pub. Date: Jun. 21, 2018

(54) SYSTEM AND METHODS FOR ELECTRONIC SCRAPBOOKING FOR USER-PARTICIPATED EVENTS

(71) Applicant: Andrew J. Savko, Little Silver, NJ (US)

(72) Inventor: Andrew J. Savko, Little Silver, NJ (US)

(21) Appl. No.: 15/850,443

(22) Filed: Dec. 21, 2017

Related U.S. Application Data
(60) Provisional application No. 62/437,367, filed on Dec. 21, 2016.

(51) Int. Cl. G06F 17/30; H04W 4/18; H04L 29/08; G06F 3/048; G06Q 50/00

(52) U.S. Cl. CPC G06F 17/30056; H04W 4/185; H04L 67/22; G06F 3/048; G06Q 50/01; H04L 67/306

(57) ABSTRACT

A method for updating user-defined statistics in an electronic scrapbook on a mobile device. The user-defined statistics are associated with events of a predetermined type to which the user has checked in. The method includes: a) receiving an input signal signaling a user check-in for a current event of a predetermined type, b) identifying user-defined statistics and associated attributes for the current event, c) identifying past events to which the user previously checked in, d) displaying values of the user-defined statistics for the past events f) retrieving information relating to or at least the current event over one or more data networks, g) calculating updated user-defined statistics for both the past and current events, and g) displaying values of the updated statistics on the display screen of the mobile device. The updated user-specified statistics are expressed only for events to which the user has currently or previously checked in.

### RELATED APPLICATION

This application claims the benefit of priority under 35 § 119(e) to U.S. Provisional Patent Application No. 62/437,367, entitled “System and Method for On-Line Scrapbooking of User Event Experiences,” filed on Dec. 21, 2016 and incorporated by reference in its entirety herein.

### FIELD OF THE INVENTION

This disclosure pertains to a system and methods for users to construct on-line electronic scrapbooks to record their participation in or viewing of certain events, and more particularly, a system and methods for on-line electronic scrapbooking that facilitates the calculation of use-defined statistics pertaining only to events participated in or viewed.

### BACKGROUND

Memories are often created by one's participation in or attendance at events. However, sometimes these memories are fleeting. Over time, it may become a struggle to remember he first baseball game we attended, who played in the game, and what memorable plays occurred during the game. In addition, we may forget who we attended the game with, and lose track of photos taken while we enjoyed the event.

With the advent of a variety of social media platforms (for example, including FACEBOOK, GOOGLE+ and INSTAGRAM), we enjoy electronically connecting with others who are attending or viewing the same events, and sharing thoughts, photos and other mementos created for remembering these events. For events that lend themselves to the consideration of statistics (for example, batting averages in baseball), it would be of interest to keep track of these statistics for the events we have attended and/or seen.

### SUMMARY

By way of example, aspects of the present disclosure are directed to a system and methods for users to construct on-line electronic scrapbooks to record their participation in or viewing of certain events, and more particularly, a system and methods for on-line electronic scrapbooking of events that are attended or observed by a user, including calculating statistics pertaining specifically to these events.

According to aspects of the present disclosure, a computer-implemented method for updating user-defined statistics in an electronic scrapbook on a mobile device.

In accordance with aspects of the present disclosure, a method is disclosed for updating user-defined statistics in an electronic scrapbook on a mobile device, the user-defined statistics being associated with events of a predetermined type to which the user has checked in. the disclosed method includes the steps of: a) receiving an input signal at user interface of the mobile device, the input signal signaling a user check-in for a current event of a predetermined type, b) identifying user-defined statistics and associated attributes for events of the predetermined type, c) identifying past events of the predetermined type for which the user previously checked in, d) displaying values of the user-defined statistics for the past events on a display screen of the mobile device, e) identifying one or more network-accessible data sources for retrieving information relating to the associated attributes for the user-defined statistics, f) retrieving information relating to the associated attributes for at least the current event from the one or more data sources over one or more data networks, g) calculating updated user-defined statistics for both the past and current events based on at least the retrieved information, and g) displaying values of the updated statistics on the display screen of the mobile device, whereby the updated user-specified statistics displayed on the display screen of the mobile device are expressed with respect only to events of the predetermined type to which the user has checked in.

In accordance with an additional aspect of the disclosure, the predetermined event type may be a sporting event, and more preferably, a major league baseball (MLB) game.

In accordance with further aspects of the disclosure, the user-defined statistics may preferably include one or more statistics selected from the group consisting of wins, losses, at bats, runs, hits, doubles, triples, home runs, runs batted in, batting average, walks, strikeouts, stolen bases and attempts caught stealing. In addition, the user-defined statistics may preferably include one or more statistics selected from the group consisting of earned run average, saves, complete games, shutouts, walks and hits per inning pitched, strike outs per walk, strike outs per 9 innings, earned runs, runs, strike outs, walks against, stolen bases against and wild pitches.

In accordance with aspects of the present disclosure, the disclosed method may further include the steps of receiving an input signal at the user interface identifying a location of the user for the current event, and/or receiving an input signal at the user interface associating a media file with the current event. The media file may, for example, comprise a photo file stored in a photo library in a memory of the mobile device. Alternatively, the media file may comprise one or more of an audio file or video file stored in the memory of the mobile device, or may comprise another media file that can be retrieved over the one or more data networks.

In accordance with additional aspects of the present disclosure, the disclosed method may further include the step of identifying one or more friends of the user to be tagged with in a social media application with information from the electronic scrapbook.

Aspects of the present disclosure further include a mobile device configured to provide an electronic scrapbook application operable for updating user-defined statistics for a current event of a predetermined type in accordance with methods disclosed by the present disclosure.

This SUMMARY is provided to briefly identify some aspects of the present disclosure that are further described below in the DESCRIPTION. This SUMMARY is not intended to identify key or essential features of the present disclosure nor is it intended to limit the scope of any claims.

### BRIEF DESCRIPTION OF THE DRAWING

A more complete understanding of the present disclosure may be realized by reference to the accompanying drawing in which:

FIG. 1 presents a schematic diagram depicting mobile device for hosting a software application performing methods in accordance with aspects of the present disclosure;

FIG. 2 presents a diagram depicting data flow in a software application performing methods in accordance with aspects of the present disclosure;

FIGS. 3A-3Q present a flow diagram and example display screens illustrating a methods for initiating an electronic scrapbook application performing methods in accordance with aspects of the present disclosure;

FIGS. 4A-4I present a flow diagram and example display screens illustrating a methods for operating an electronic scrapbook application in accordance with aspects of the present disclosure to check in with regard to a current event;

FIGS. 5A-5H present a flow diagram and example display screens illustrating a methods for adding a memento listing for association with the current event in an electronic scrapbook application in accordance with aspects of the present disclosure; and

FIGS. 6A-6G present a flow diagram and example display screens illustrating a methods for viewing user-specified statistics for events that the user has check into in an electronic scrapbook application in accordance with aspects of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

Aspects of the present disclosure are directed to methods for implementation as a web-based application (in particular, as a mobile application) to allow an individual user to compile a unique database relating to specific events that the user either specifically witnessed first-hand, or viewed via some other media outlet (an “electronic scrapbook”).

In accordance with aspects of the present disclosure, each individual user establishes a user account for the electronic scrapbook. This User Account will preferably contain profile information for the user (for example, name, email address, city, state, and other user preferences). The user will then create a unique User Account Page (“User AP”) within their User Account to begin compiling their unique database. The User AP may preferably be displayed, for example, on a mobile device as a “home screen” or “home page.” The user may choose to establish multiple User APs to track multiple databases. To populate these databases, the user can access historic information either held locally or available from a third-party data source to track events that the user either witnessed via some media outlet or events that were actually witnessed live by the user.

For a given user database, the user may select which individual event details or statistics they are interested in. For example, specific event related details may include sports statistics, concert information, and the like. In addition to event-specific and/or date-specific information downloaded, for example, from a third-party data source, the user may preferably insert their own specific information (“User Specific Details”) relating to the event (for example, identifying a sporting even as the user's first game ever attended, or first time appearing on the Venue's JUMBOTRON/KISSCAM, a first date, and so on).

In accordance with further aspects of the present disclosure, the user may elect to share information from the electronic scrapbook other users via social media. This can advantageously allow users to unite or align themselves with other users to create groups that have similar interests or common experiences (thus creating a “Club”). Clubs can then communicate amongst themselves and coordinate “meet ups” or “get-togethers.”

The mobile application may allow users to utilize some of the native functions on their mobile device. For example, upon identifying a specific event that the user is attending, the user may engage the application to automatically determine the user's location using a GPS function built into the mobile device. The mobile application may advantageously use this information together with time and date information to identify the event, and then start collecting data for that particular event, for example, from a third-party data source.

The user may also use a camera function of the mobile device to take pictures to memorialize the event, and add these pictures to the user database via a “memento” function of the application. The application may preferably include an “I AM HERE” function that utilizes a “push” or “pop up” notification function of the mobile device to send out a notification from the user to other users at the specific event, allowing for real-time interaction among Club members. An instant messaging function of the mobile device, for example, may be used to allow users to communicate with other Club members either while attending an event, or at other times to plan for future events.

As more events and details/statistics/photos are added to the user's User AP, a “scrapbook” or “diary” will start to take shape. A historic account of events either attended by the individual or witnessed via a media outlet by the individual will be created and based on the event details or statistics selected by the user, the account will be unique to that individual.

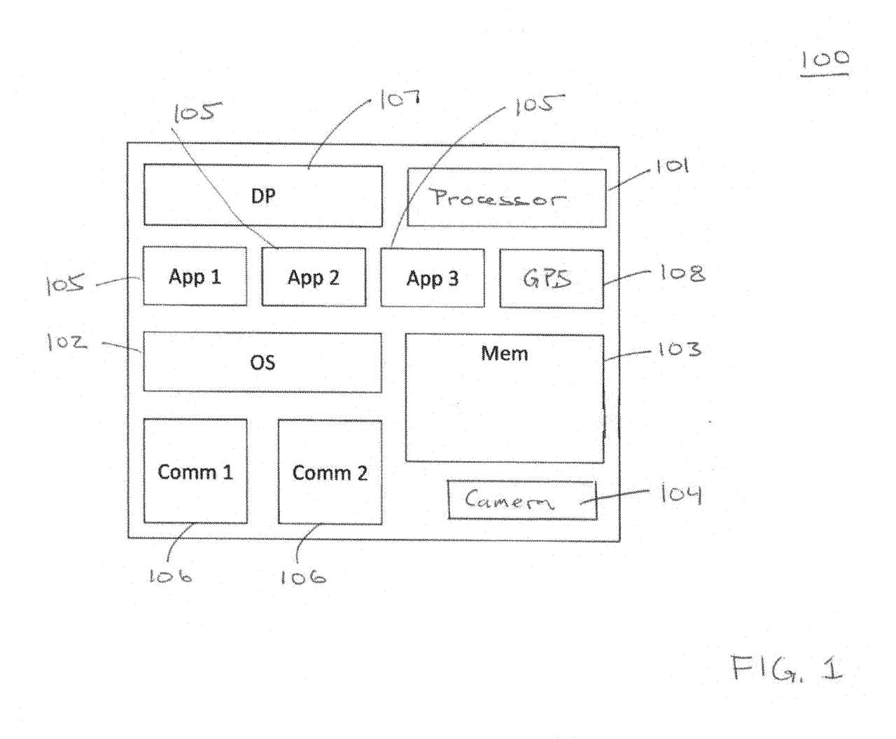

We now turn to a further description, with reference to the drawing figures. FIG. 1 provides a schematic diagram that depicts a typical mobile device 100 that may be used to carry forth the methods described in the present disclosure. It should be noted that these methods can be implemented within a variety of computer-based devices, preferably including mobile devices such as smartphones. The mobile device 100 includes a processor 101 that is operated by means of an operating system (OS) 102. The OS 102 may operate one or more software applications 105 (App 1, App 2, App 3) that are installed on the mobile device 100, including an electronic scrapbooking application that embodies the methods described herein. In addition, the mobile device 100 may preferably include a GPS unit 108 and camera unit 104 that may be operated in conjunction with the electronic scrapbooking application.

The mobile device 100 depicted in FIG. 1 further comprises a memory (Mem) 103 for data storage. The memory 103 or parts thereof may be part of the mobile device 100 itself, or alternatively, may be part of a peripheral connected to the device (for example, a peripheral such as SIM card, a smartcard, a flash drive and/or other external memory device that supports security features).

As shown in FIG. 1, the mobile device 100 preferably includes one or more network interfaces 106 (Comm 1, Comm 2) for communicating with one or more external networks, for example including cellular mobile networks (GSM, UMTS, LTE, 5G, CDMA), wireless local area networks (WLAN) including WiFi networks, short range networks (BLUETOOTH, ZIGBEE) and/or near field communication networks. The mobile device 100 also has a display (DP) 107 (for example, a touch screen display) to facilitate interaction with a user of the mobile device 100, and to render a user interface generated by the OS 102.

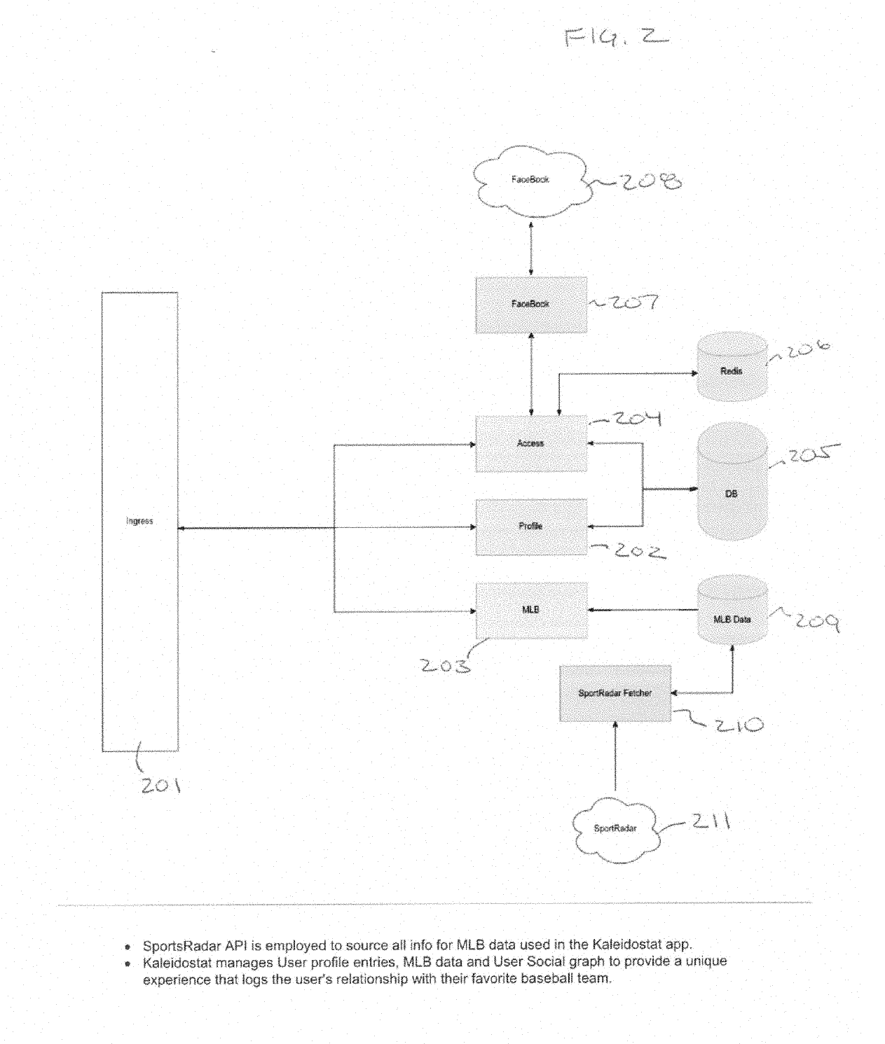

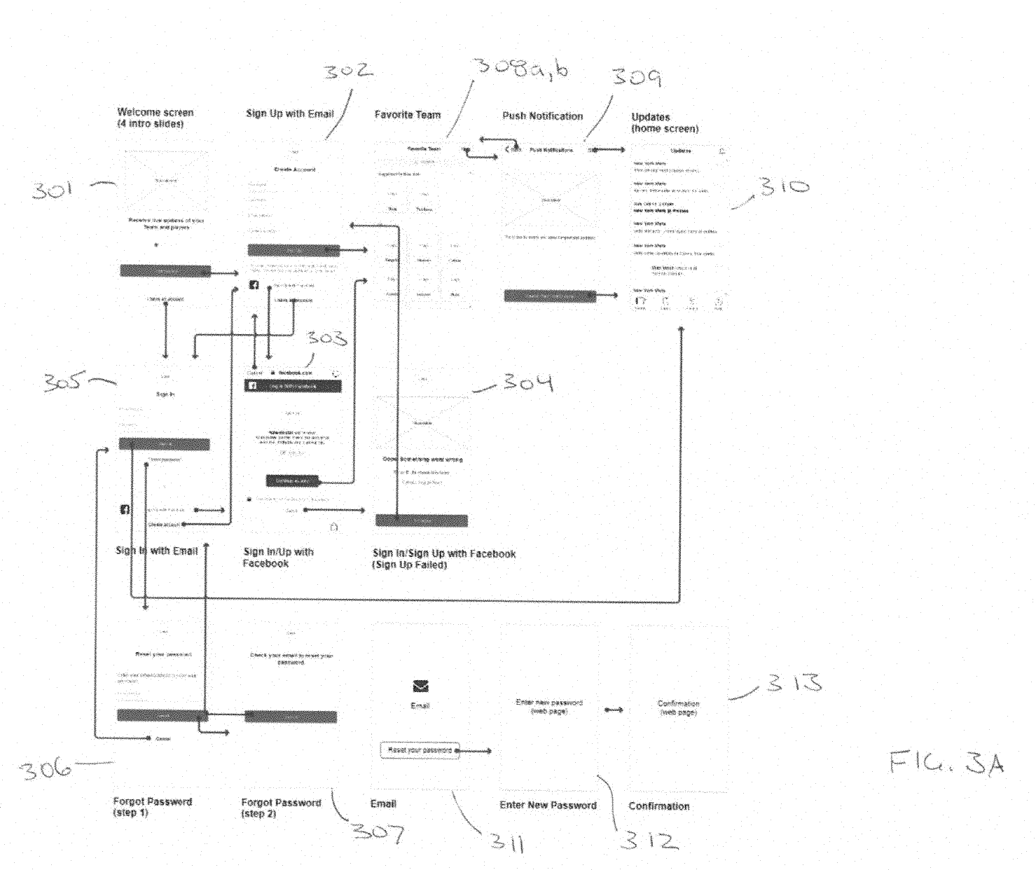

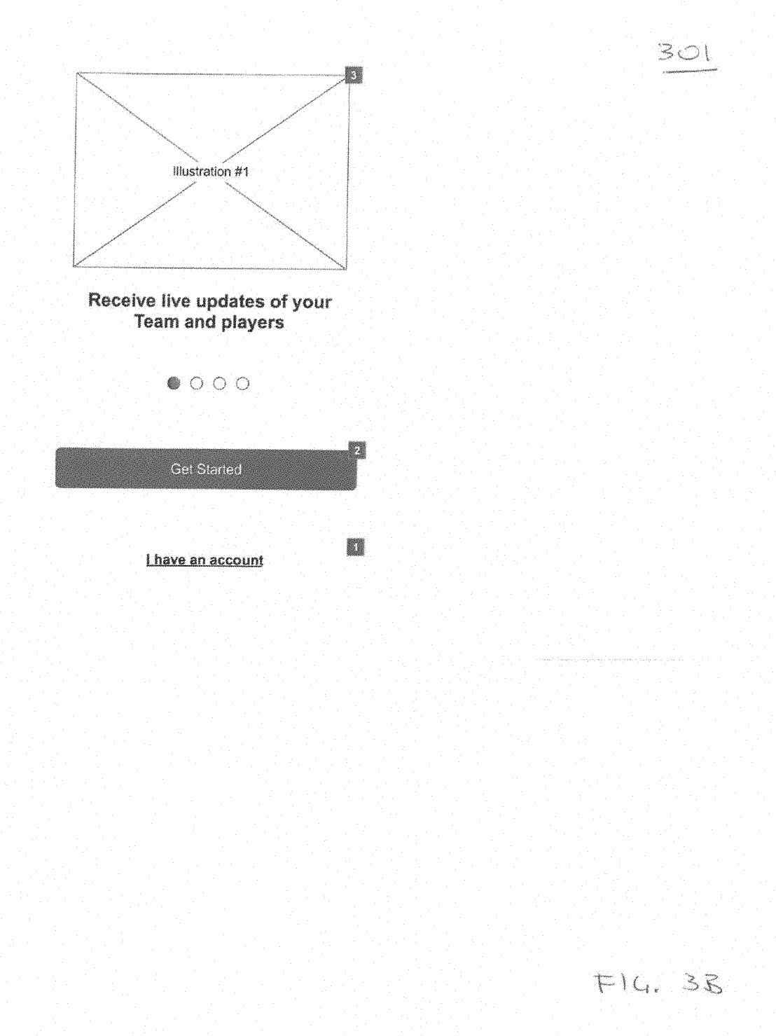

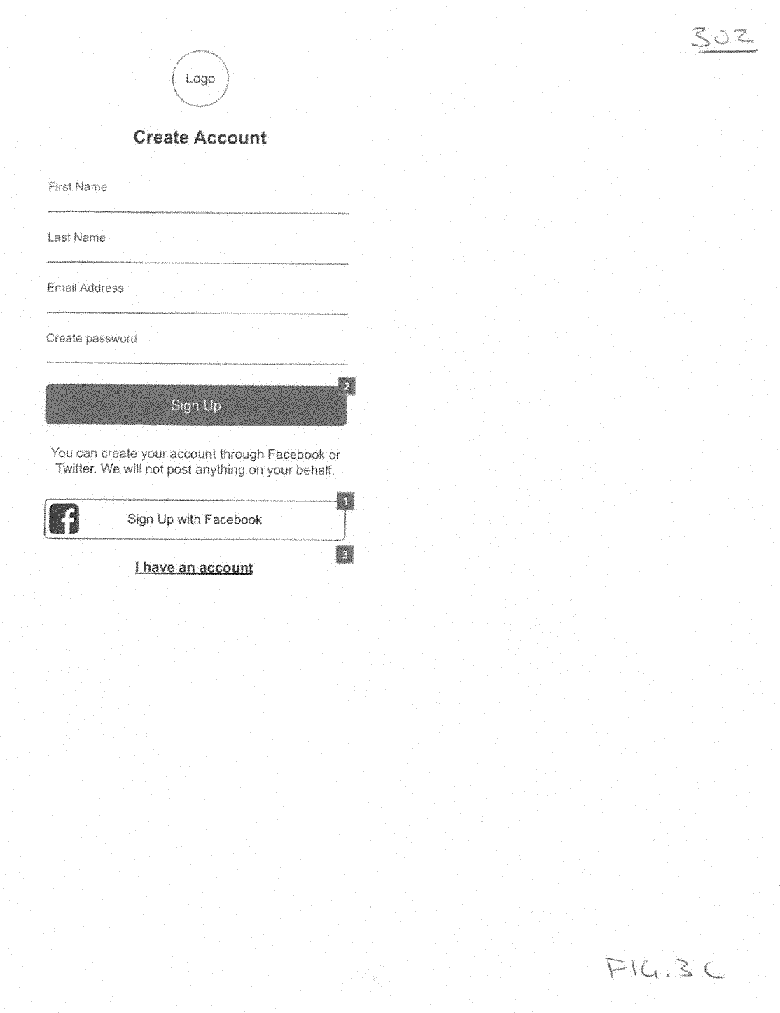

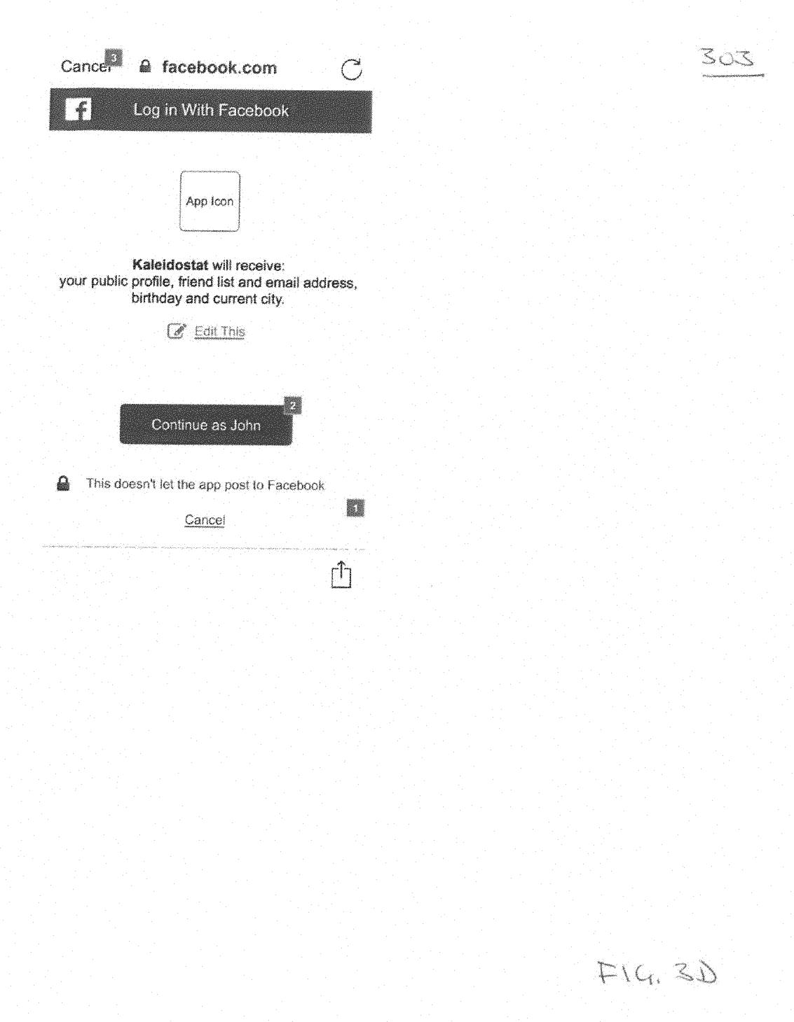

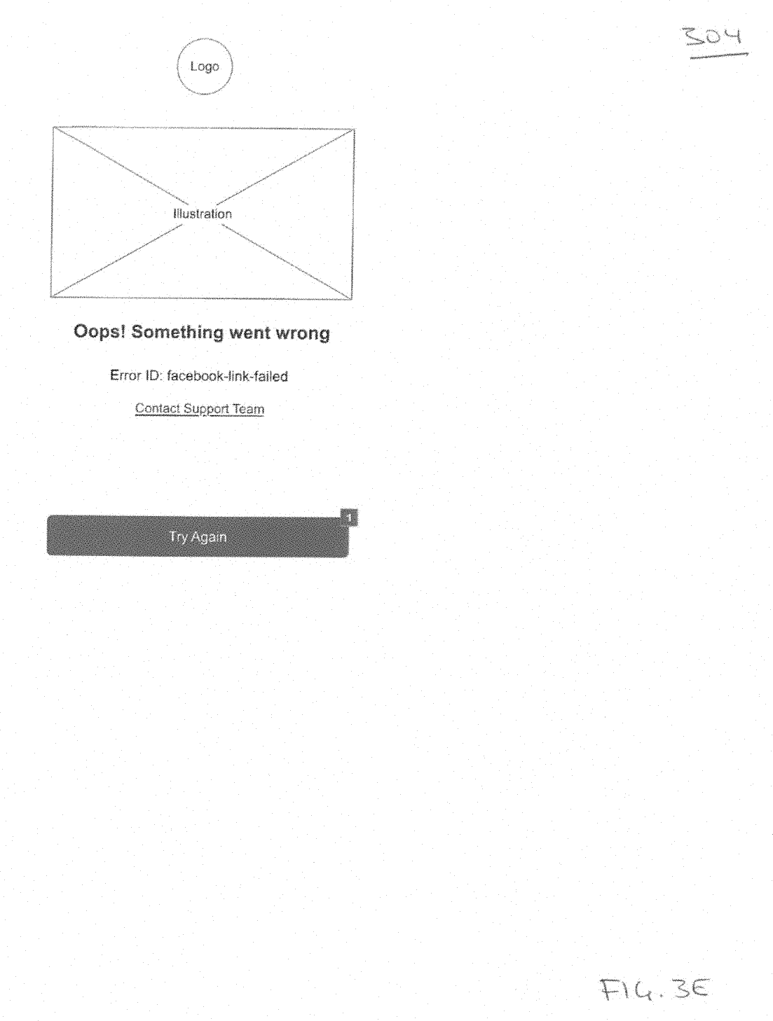

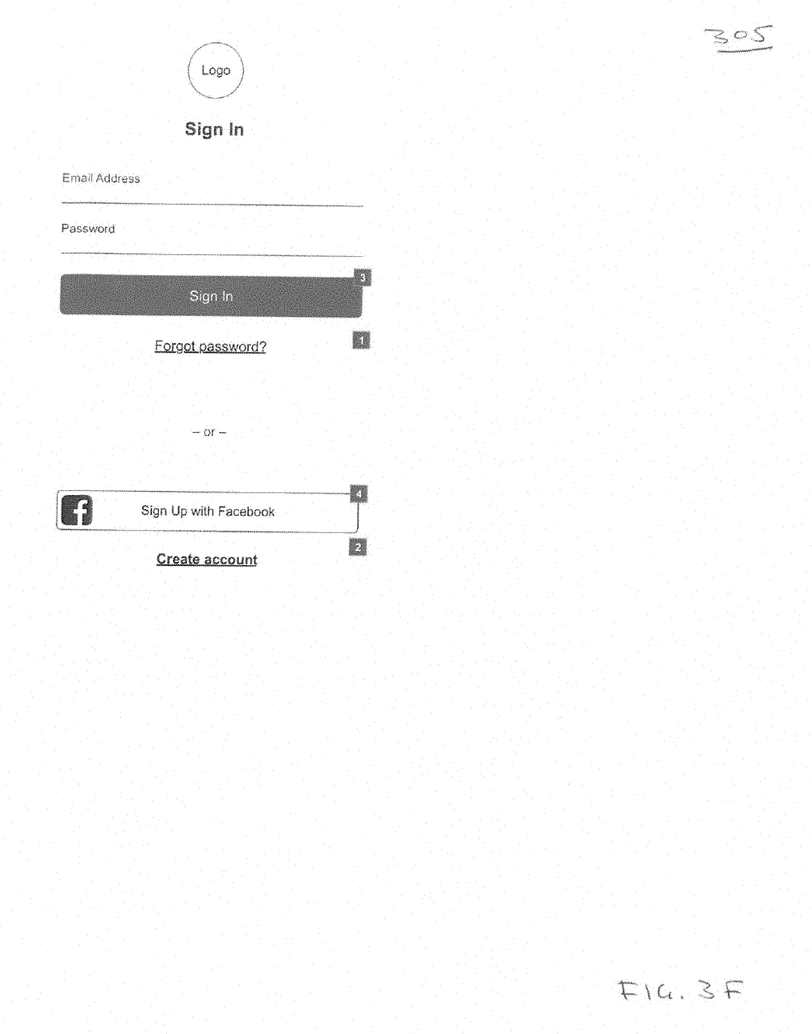

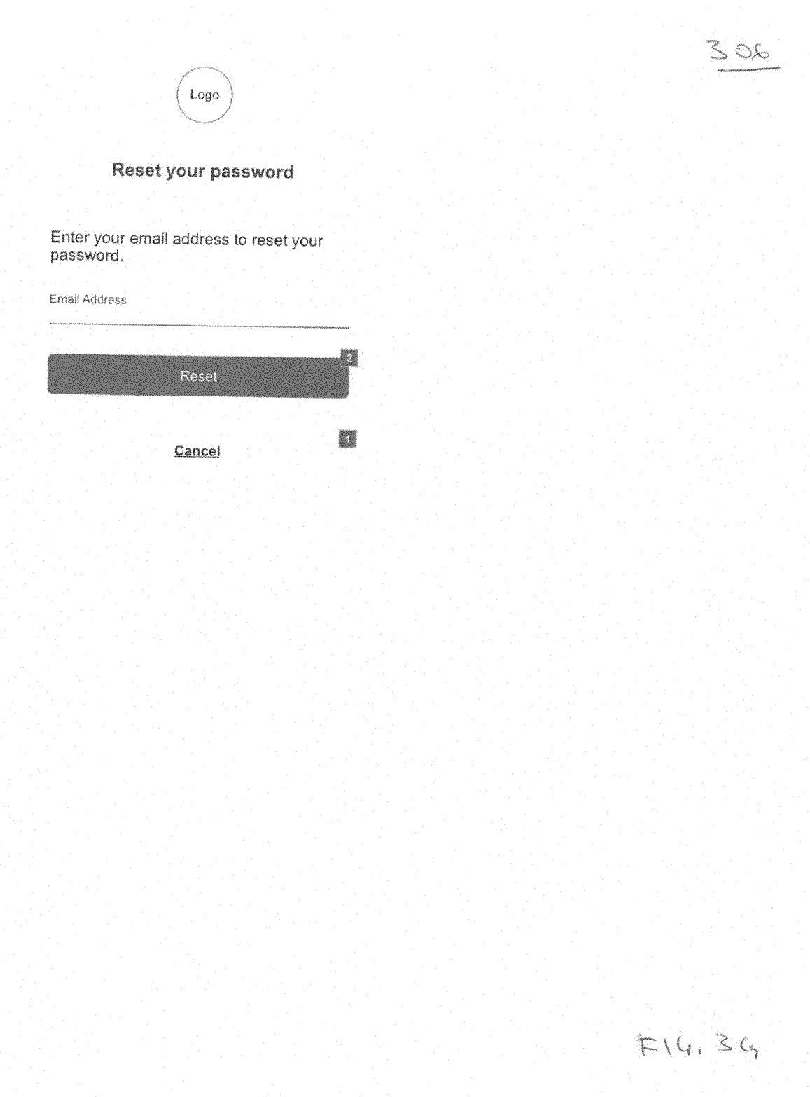

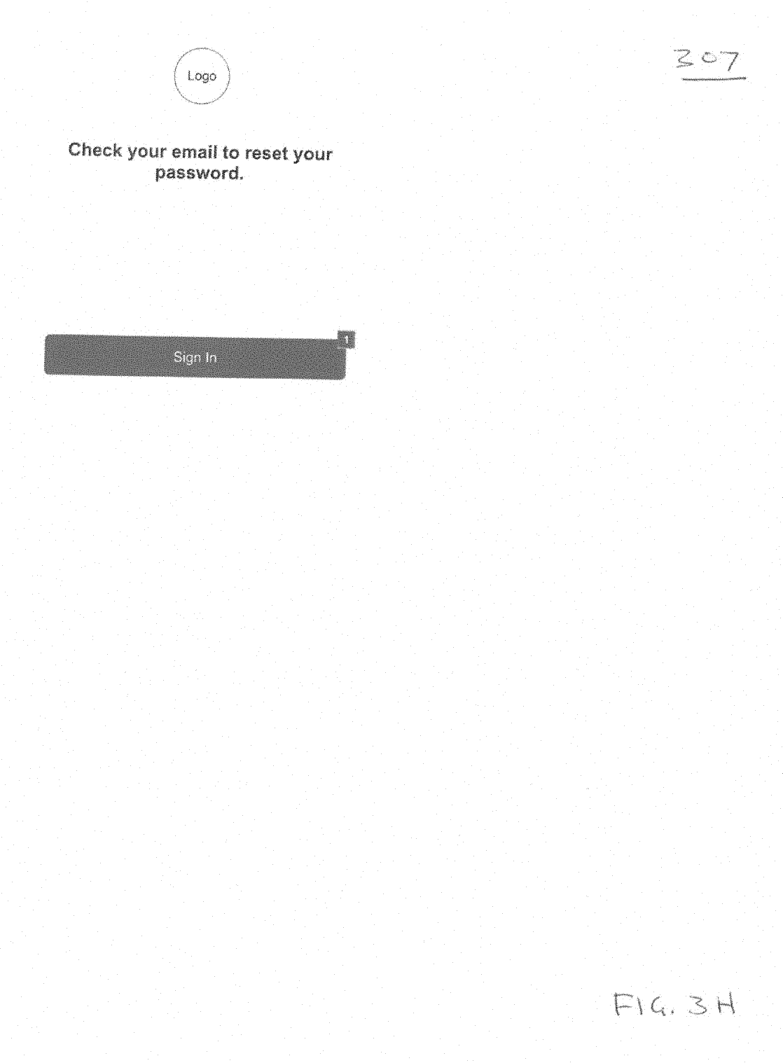

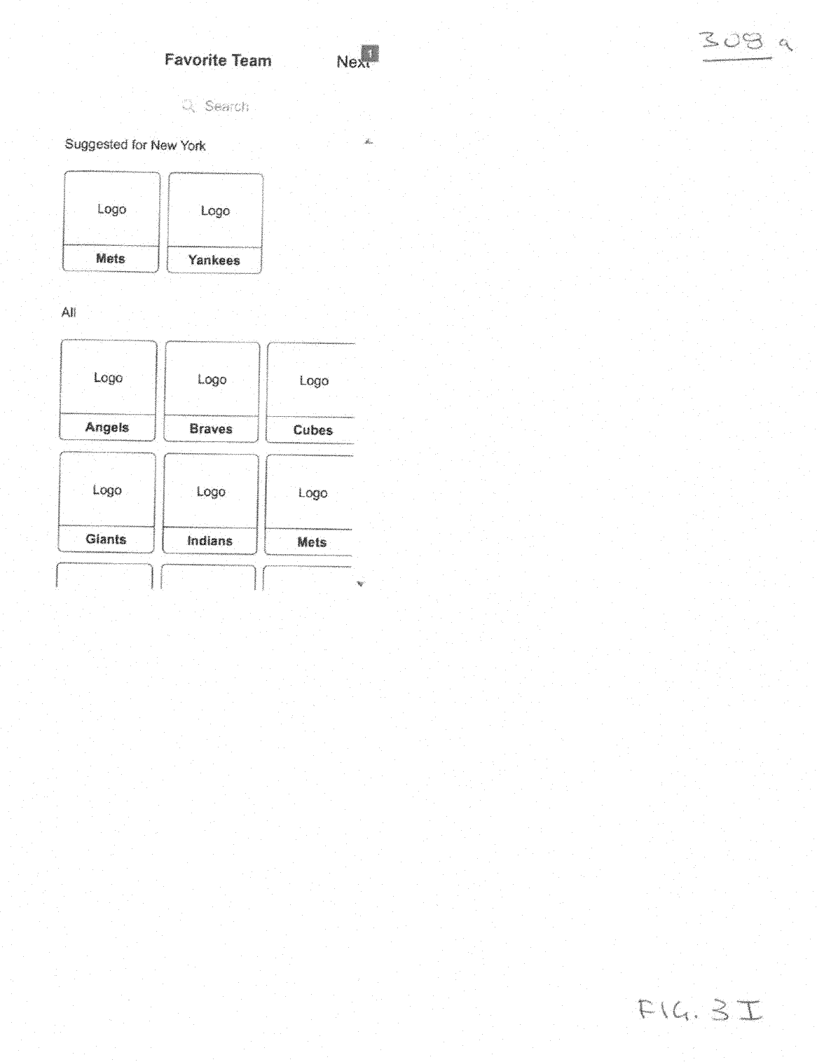

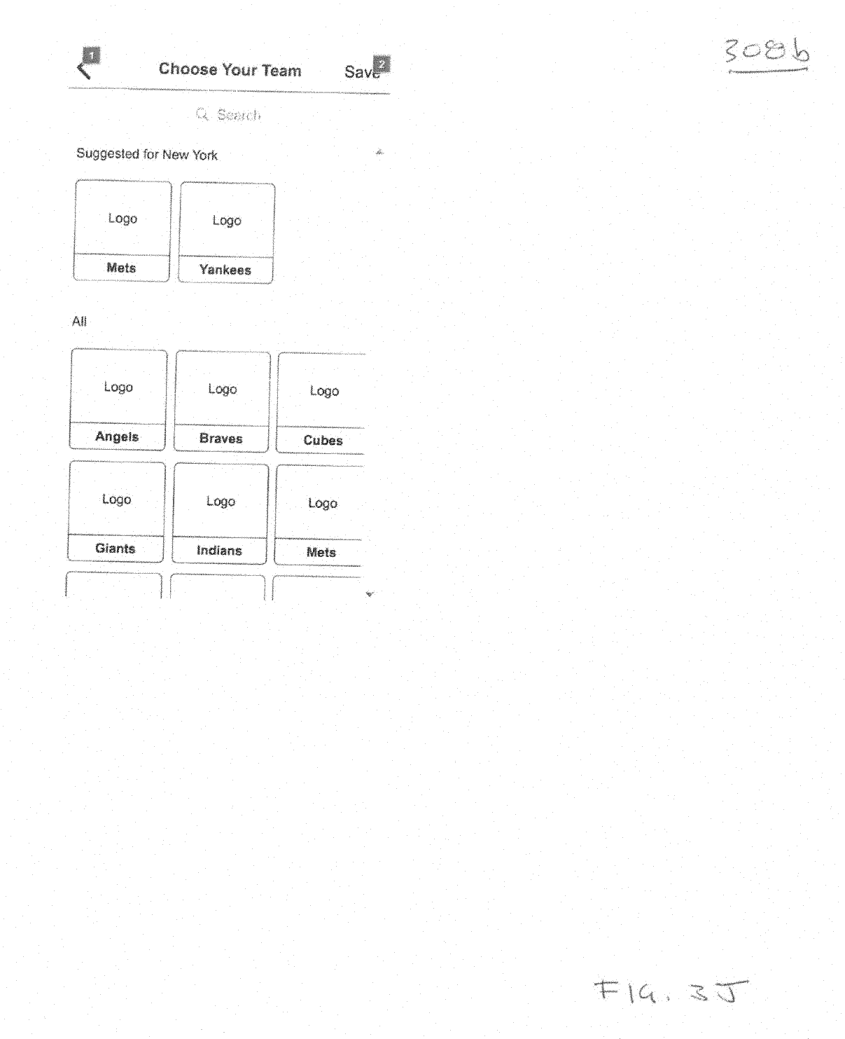

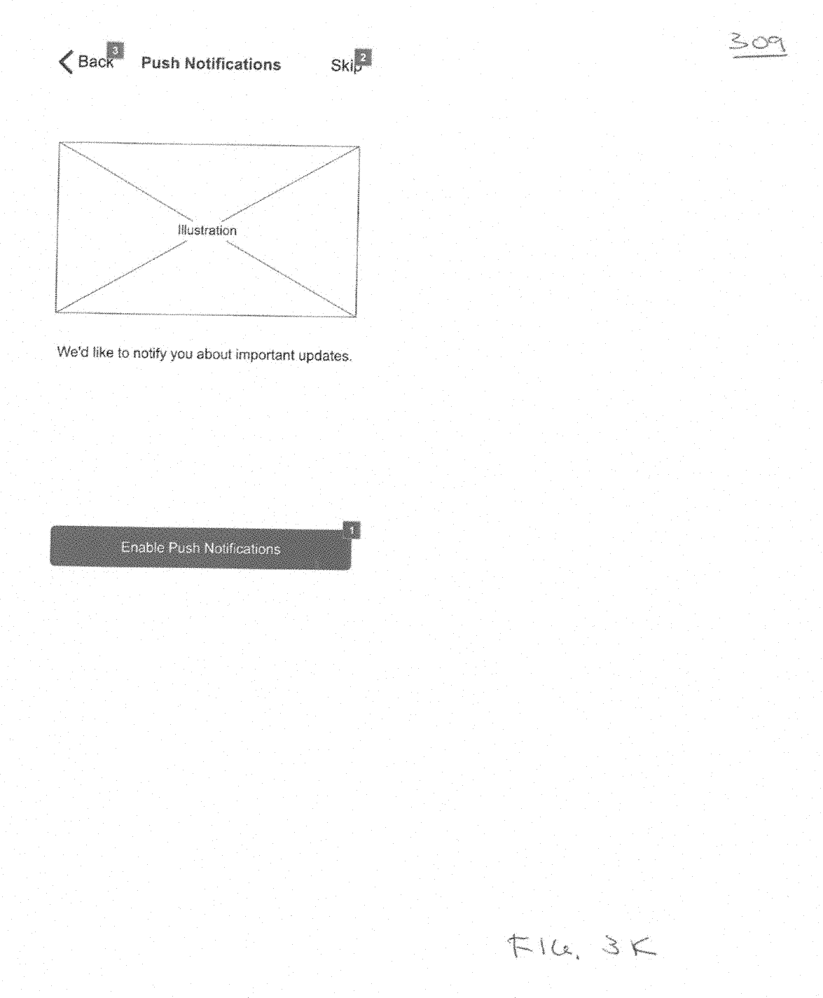

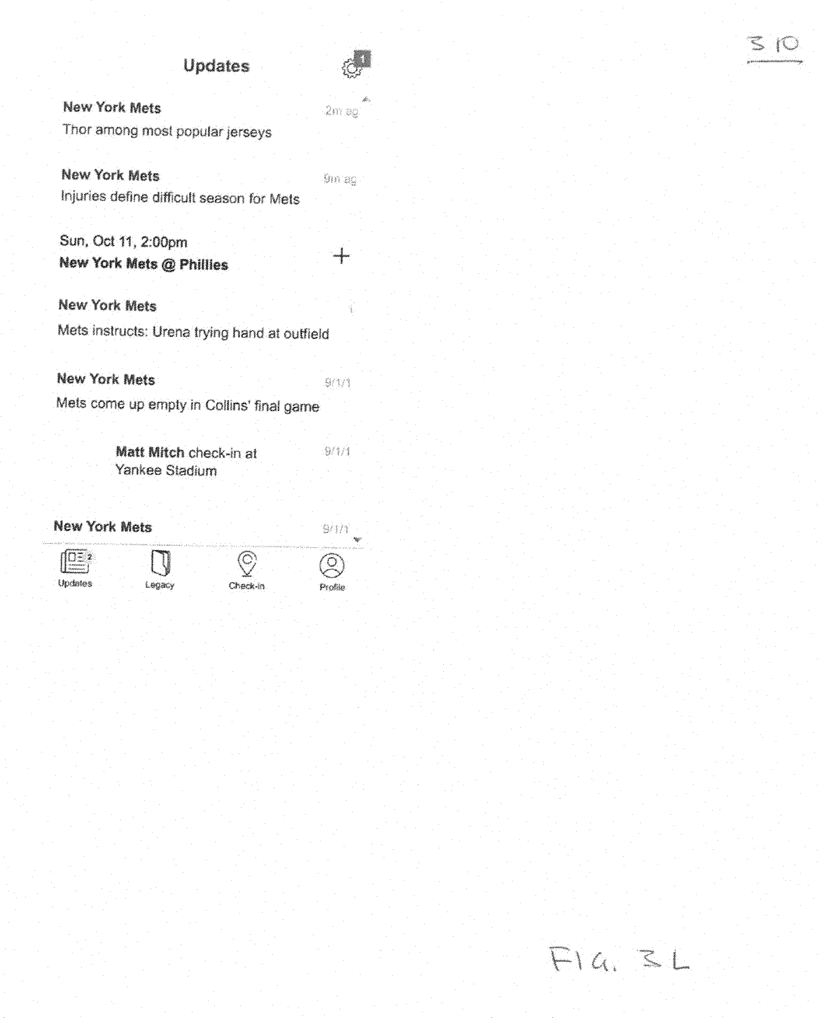

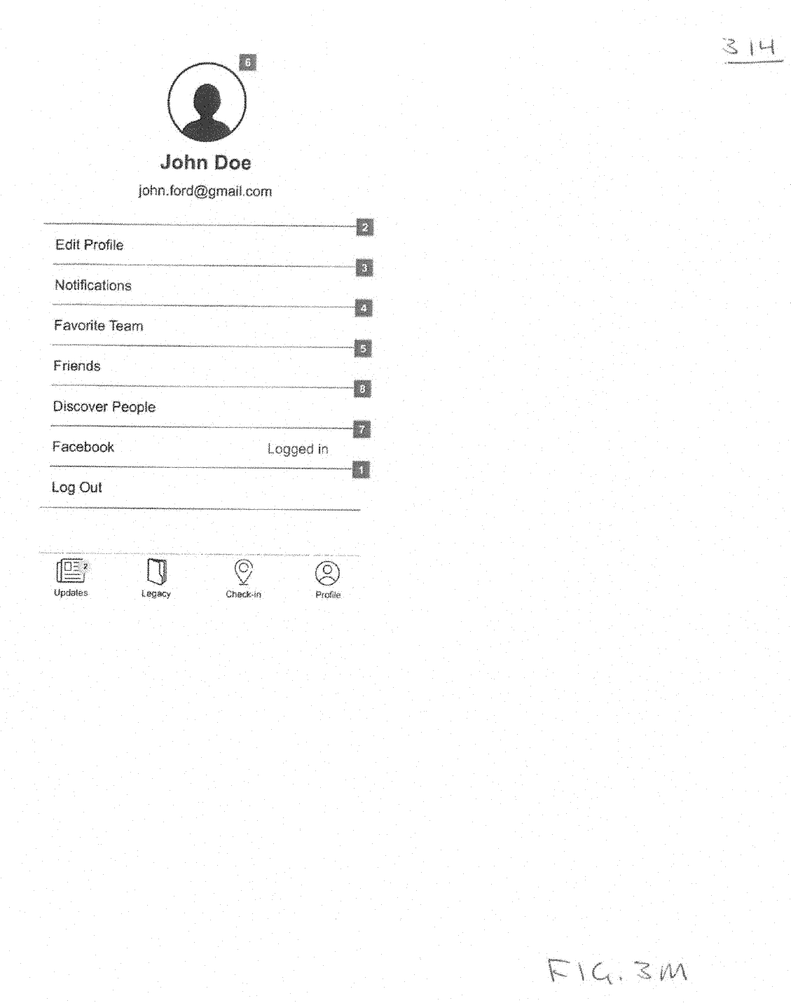

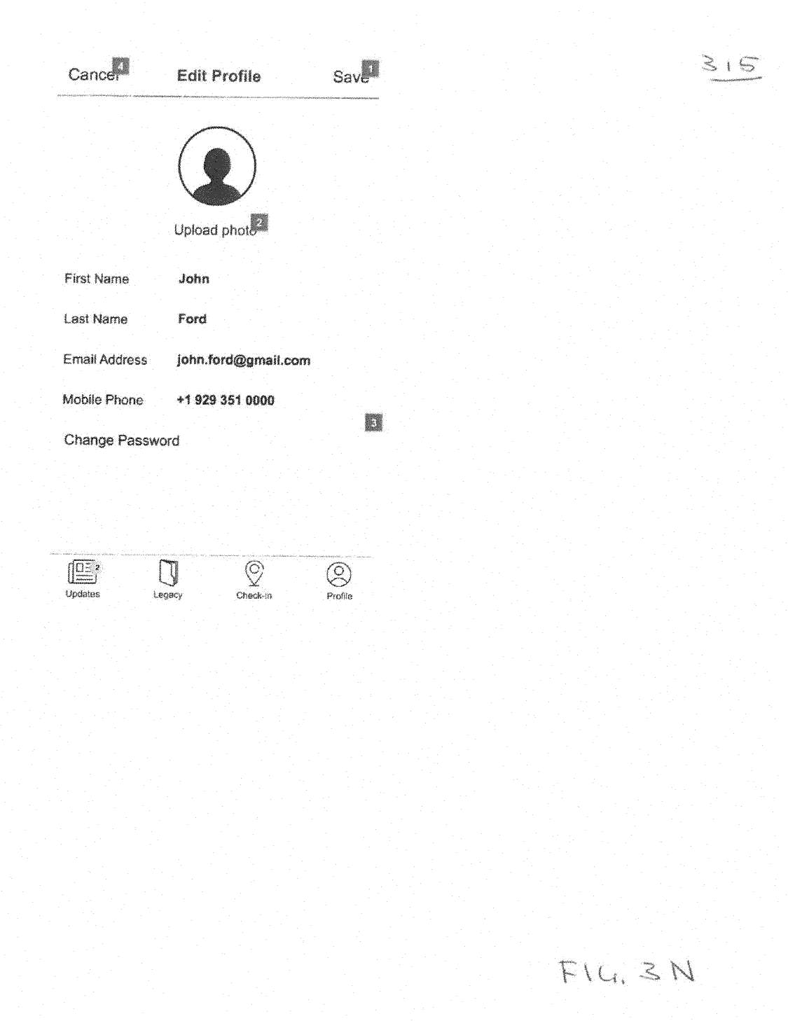

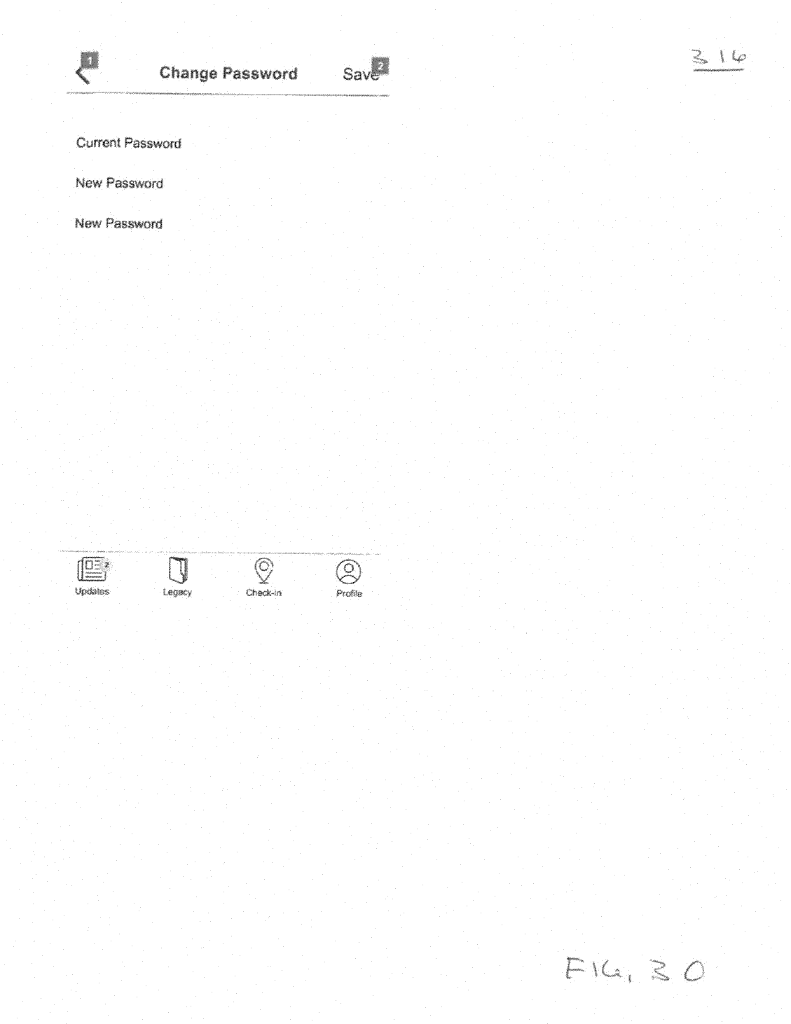

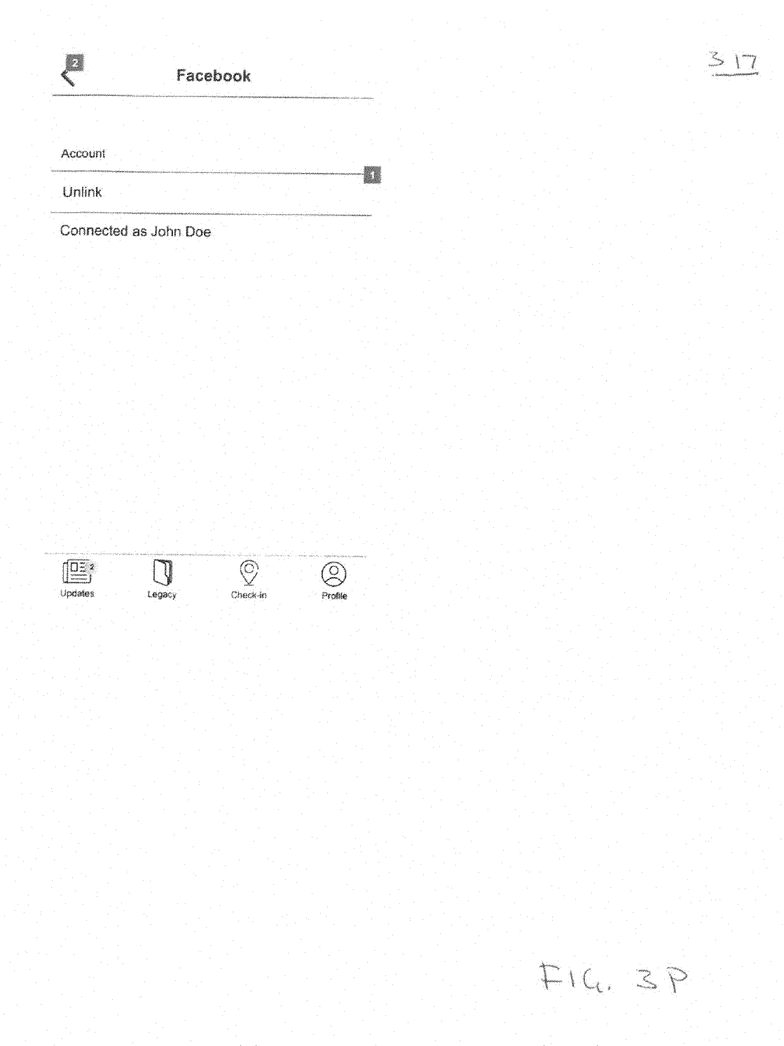

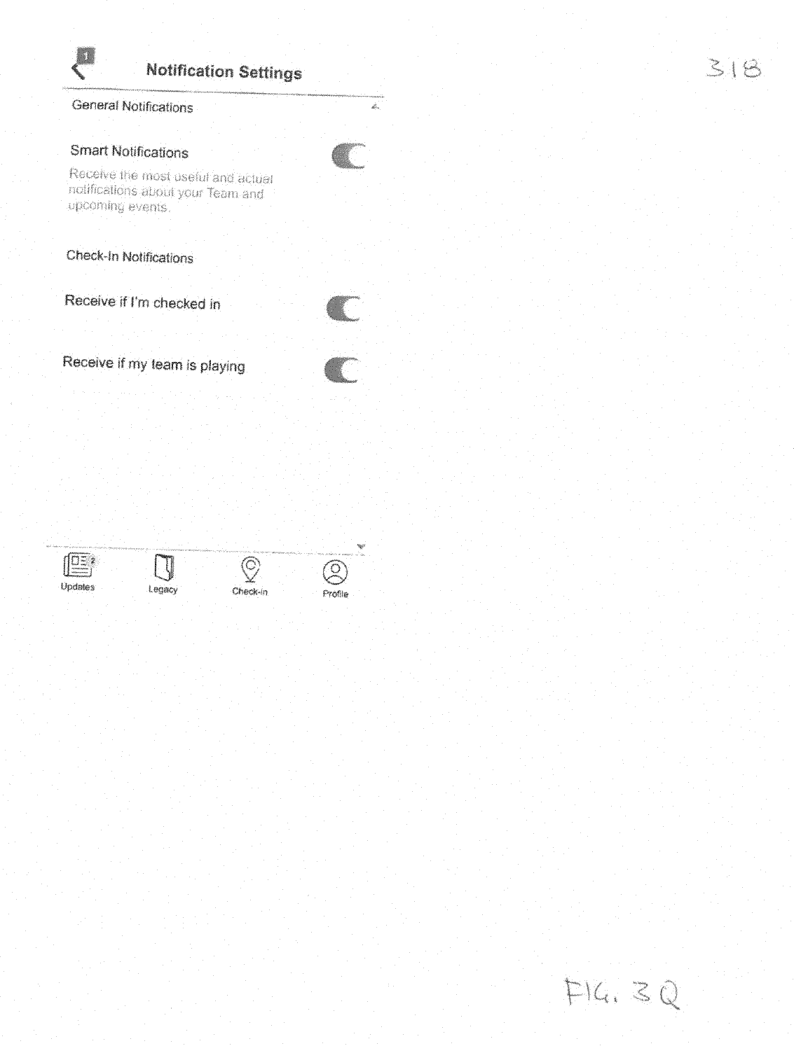

FIG. 2 presents a diagram depicting data flow in a software application embodying methods disclosed by the present disclosure. An ingress module 201 interacts with the user via the display 107 of the mobile device to manage interactions with a profile module 202, event data module 203 and access module 204. The access module 204 preferably manages user sign-in to the scrapbook application (for example, with authentication performed via by third-party application such as FACEBOOK or third-party e-mail service provider), as well as authorizing other users for sharing via social media applications. The profile module 202 preferably manages the recording and updating of user identification and preference information with regard to the application (for example, including information such as name, e-mail address, phone number, favorite teams for applications relating to sporting events, application notification preferences, and the like). Access module 204 and profile module 202 may preferably be supported by a database 205, and access module 204 may in addition be preferably supported by a data cache 206. For use of third-party applications for user authentication, an authentication module 207 (for example, using FACEBOOK as the authentication agent) may preferably be provided to access the third-party provide 208 over a network (for example, over the internet).

Event data module 203 manages to collect event data in accordance with user preferences. For example, for a user scrapbook directed to major league baseball (MLB), event data module 203 for example may aggregate schedules for a favorite team of the user and statistics for games attended or watched by the user, and store this information in an event database 209. An event data provider module 210 may preferably be provided to access third-party event data providers 211 (for example, for sporting events, accessing SPORTRADAR via a SPORTRADAR API).

FIGS. 3A-3Q present a flow diagram and example display screens illustrating a methods for initiating an electronic scrapbook application performing methods in accordance with aspects of the present disclosure. FIG. 3A presents the flow diagram. Welcome screen 301 (also illustrated in FIG. 3B) enables a user to begin initiation of the application by selecting a “Get Started” button. Screen 302 (also illustrated in FIG. 3C) is then presented to user, inviting the creation of a new user account. For example, screen 302 invites the user to provide basic identifying information (first and last name, e-mail address and password) and then select a “Sign Up” button. Alternatively, the user may elect to indicate that he or she already has an account, or elect to sign in via a third-party authenticator (for example, via FACEBOOK).

If the user opts to sign in using his or her FACEBOOK account, a FACEBOOK sign-in screen 303 (also illustrated in FIG. 3D) is presented for user selection. If the user proceeds to select this option, a screen 304 (also illustrated in FIG. 3E) is presented in the event that the FACEBOOK sign-in is unsuccessful. The user may then select a “Try Again” button to return to screen 302.

As an alternative, upon presentation of welcome screen 301, the user may choose sign-in directly to the electronic scrapbook application. In that case, the user is presented with sign-in screen 305 (also illustrated in FIG. 3F). If the user has forgotten his or her password, he or she may select a “Forgot Password” button on the screen 301 and be presented with forgot password screen 306 (also illustrated in FIG. 3G), which will enable the user to provide his or her e-mail address and execute a password reset. Upon executing this request, the user may be presented with a message screen 307 (also illustrated in FIG. 3H). As illustrated in FIG. 3A, the electronic scrapbook application user may then direct the user to an e-mail screen 311 providing a password reset button which, when executed, causes the application to present a new password entry screen 312 to the user. Upon entry of the new password by the user, the application may present a confirmation screen 313 indicating that the password update was successfully completed. Alternatively, the password update function may require the user to directly access an e-mail application on the mobile device 100.

Once a user account has been created via screen 302, the user may proceed to provide additional details for managing the account. For purposes of illustrating this and other aspects of the electronic scrapbook application, specific examples are presented for a scrapbook directed to Major League Baseball (MLB) events. It should be understood once again that these specific examples are provided for pedagogical purposes to aid the reader in understanding the principles of the disclosure and the concepts contributed by the inventor(s) to furthering the art, and are to be construed as being without limitation to such specifically recited examples and conditions.

For example, upon sign-in, the user may be presented with one of favorite team screens 308a, b (also illustrated in FIGS. 3I, 3J), which will enable the user to select a favorite team so that associated events for that team can be notified to the user. The user may then be presented with push notification screen 309 (also illustrated in FIG. 3K) to indicate whether the user wishes to enable push notification to his or her mobile device 100 concerning team events and other team news. If the user enables these notifications, he or she may then be presented with an update screen 310 (also illustrated in FIG. 3L) that provides notification of team events and other team news. As illustrated in FIG. 3L, for example, the other notifications may for example include news feeds and notifications concerning friends who are currently participating in or observing associated events.

The electronic scrapbook application may preferably provide the user with additional means for managing the user's associated account and preferences. For example, as illustrated in FIG. M, a user screen 314 may be provided to the user to launch additional screens directed to editing the user's profile, changing a password, updating FACEBOOK account details, and adjusting notifications. FIG. 3N illustrates an edit profile screen 315 that may be used by the user to update name, e-mail and phone information. If the user for example elects to update his or her password information, he or she may be presented with change password screen 316 (as illustrated in FIG. 3O. If he or she chooses to update FACEBOOK account details, FACEBOOK screen 317 (as illustrated in FIG. 3P) may be presented on the mobile device 100. If the user chooses to update notification details, notification settings screen 318 (as illustrated in FIG. 3Q) may be presented on the device 100. As illustrated in FIG. 3Q, the notification settings screen 318 may preferably enable the user to elect to receive notifications (“Smart Notifications”), and also to elect to receive these continuously or only at certain times (for example, when the user is “checked in” to the electronic scrapbook application or while the user's favorite team is playing).

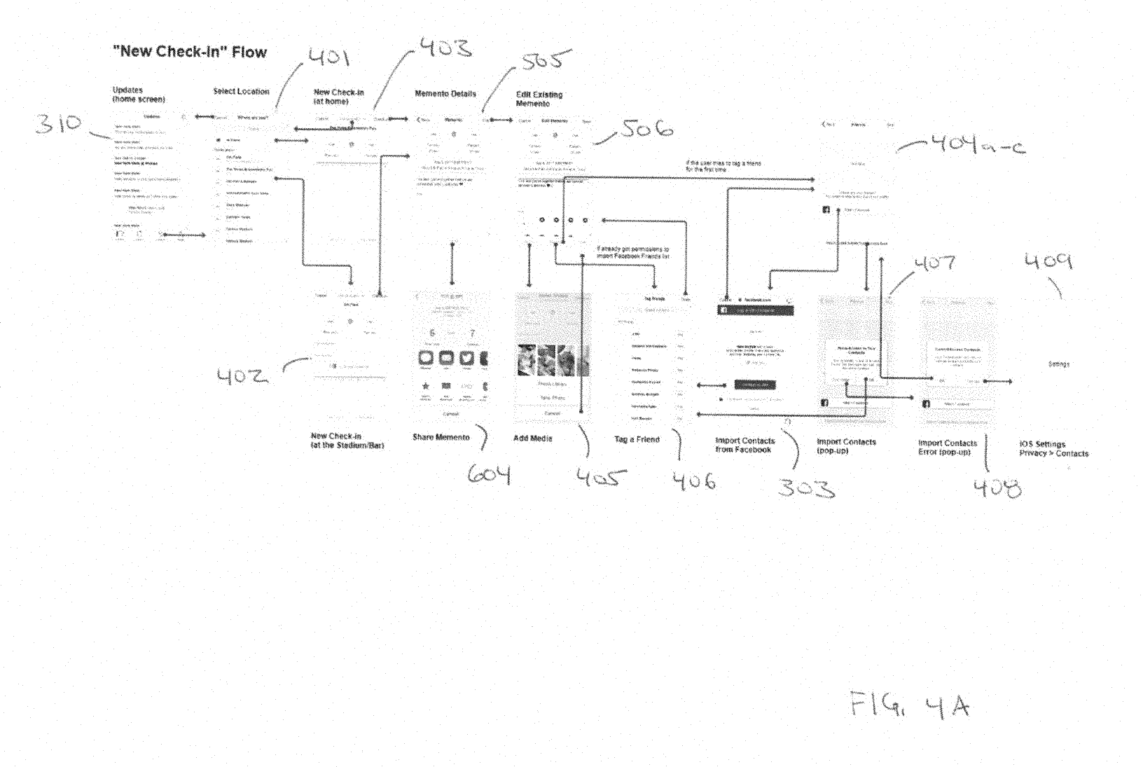

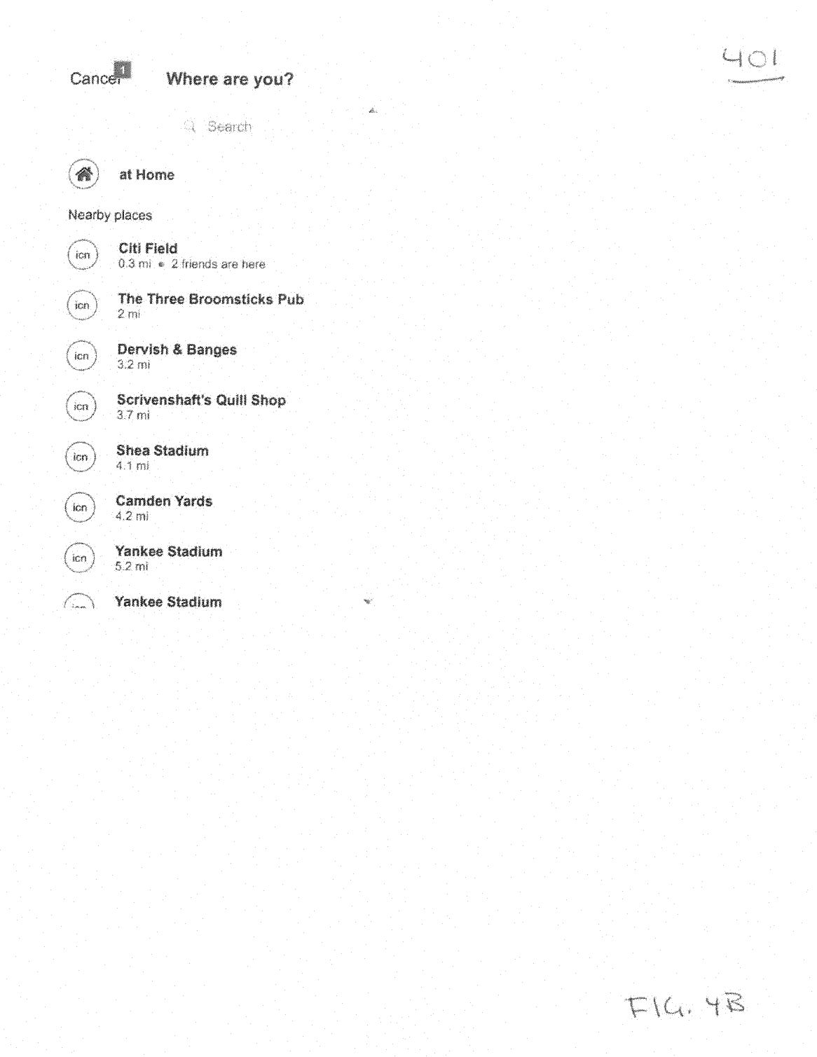

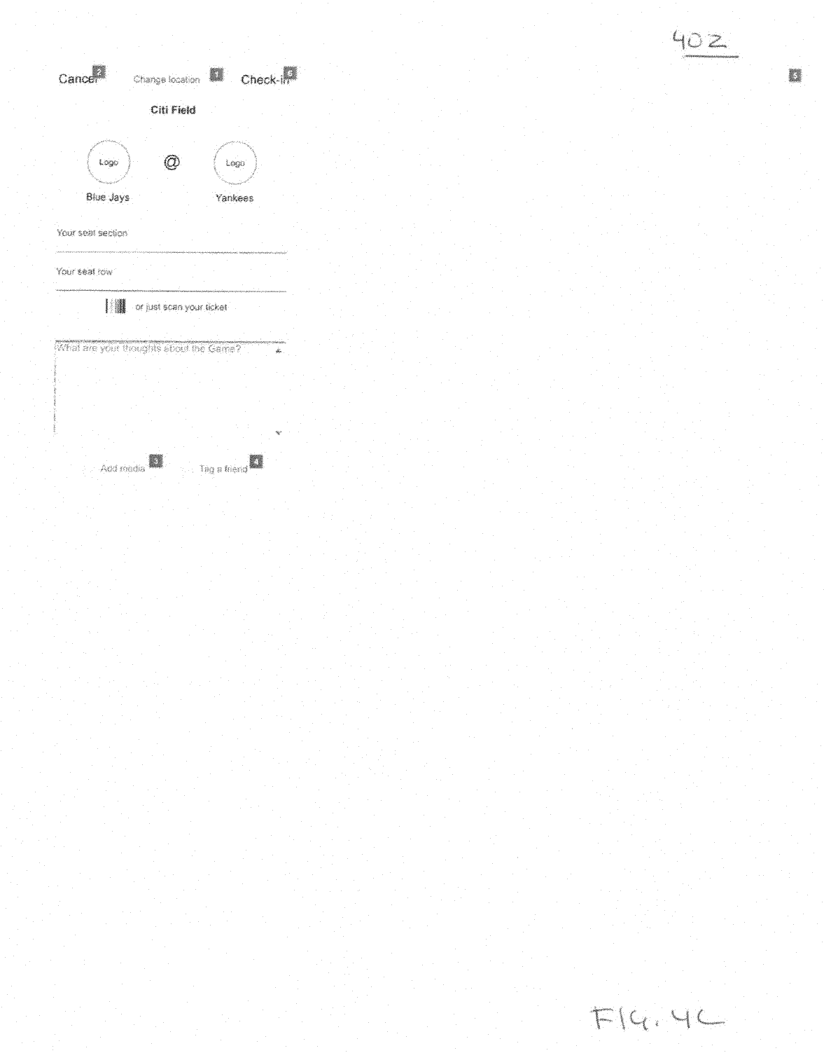

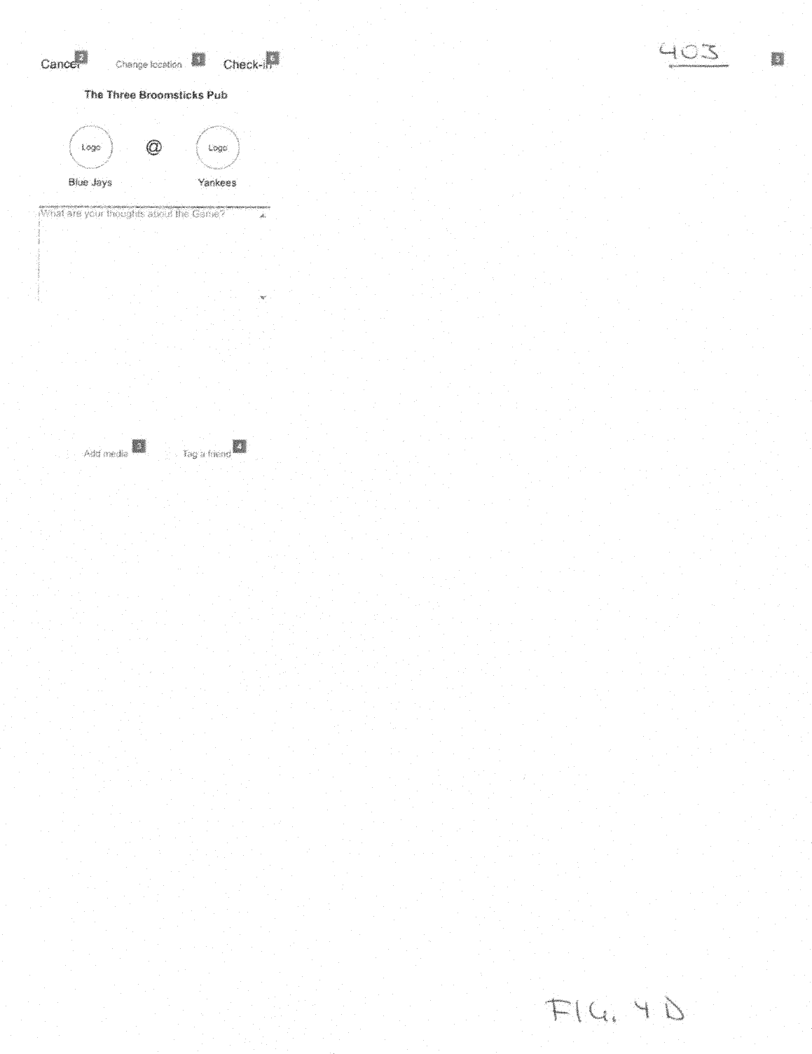

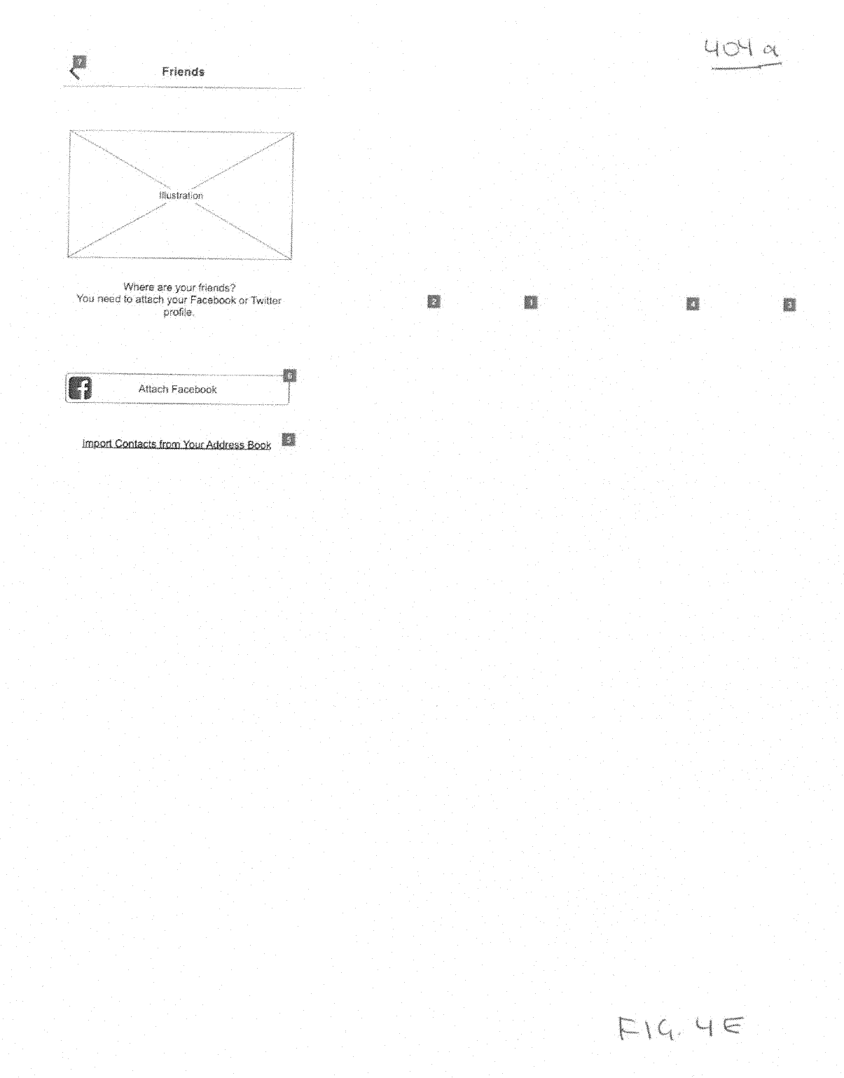

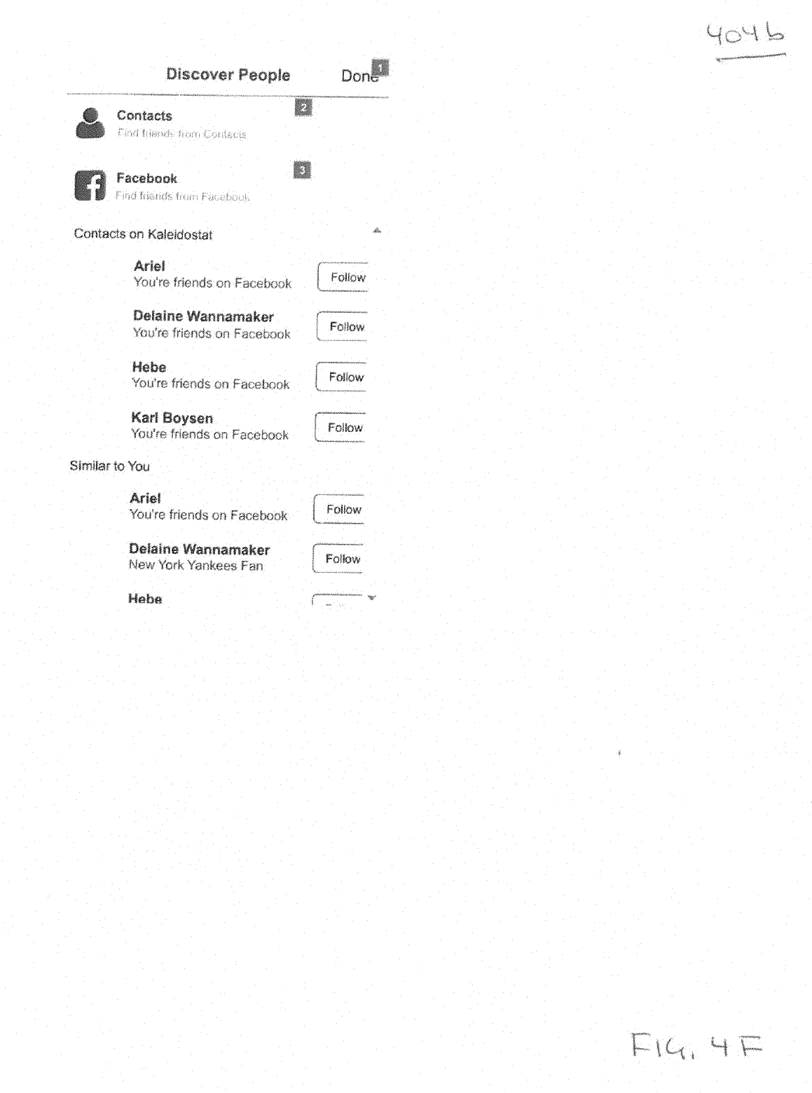

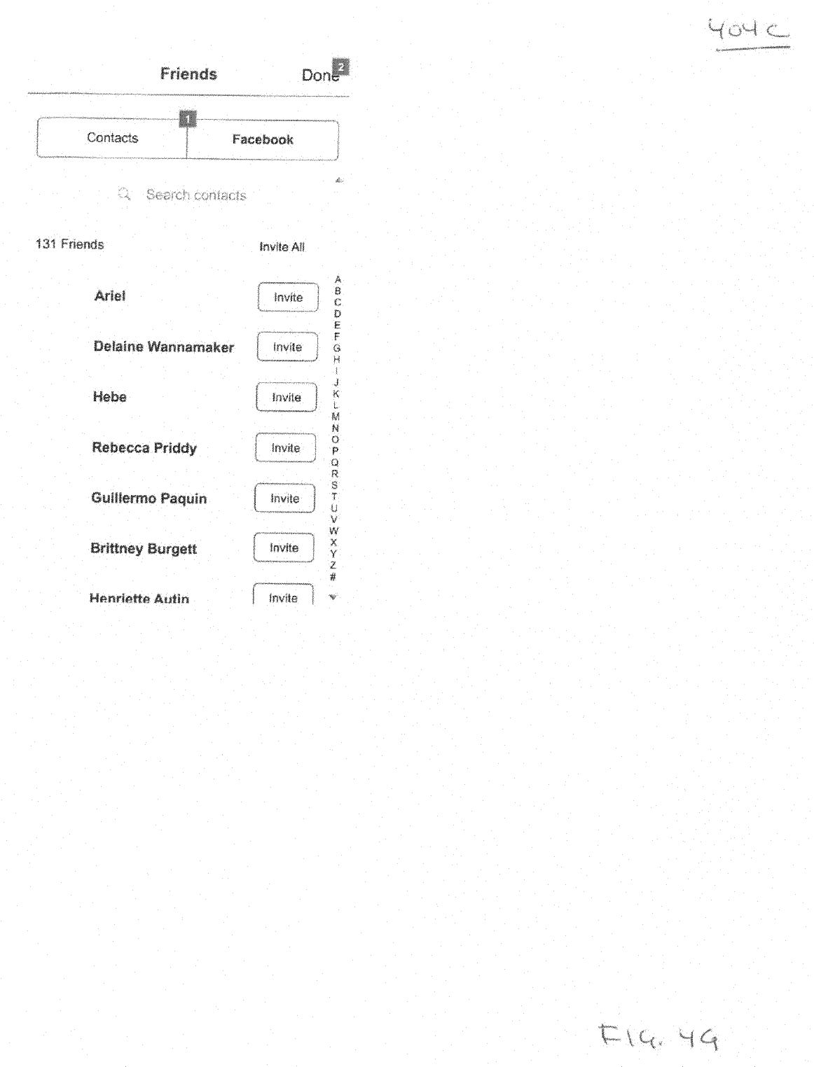

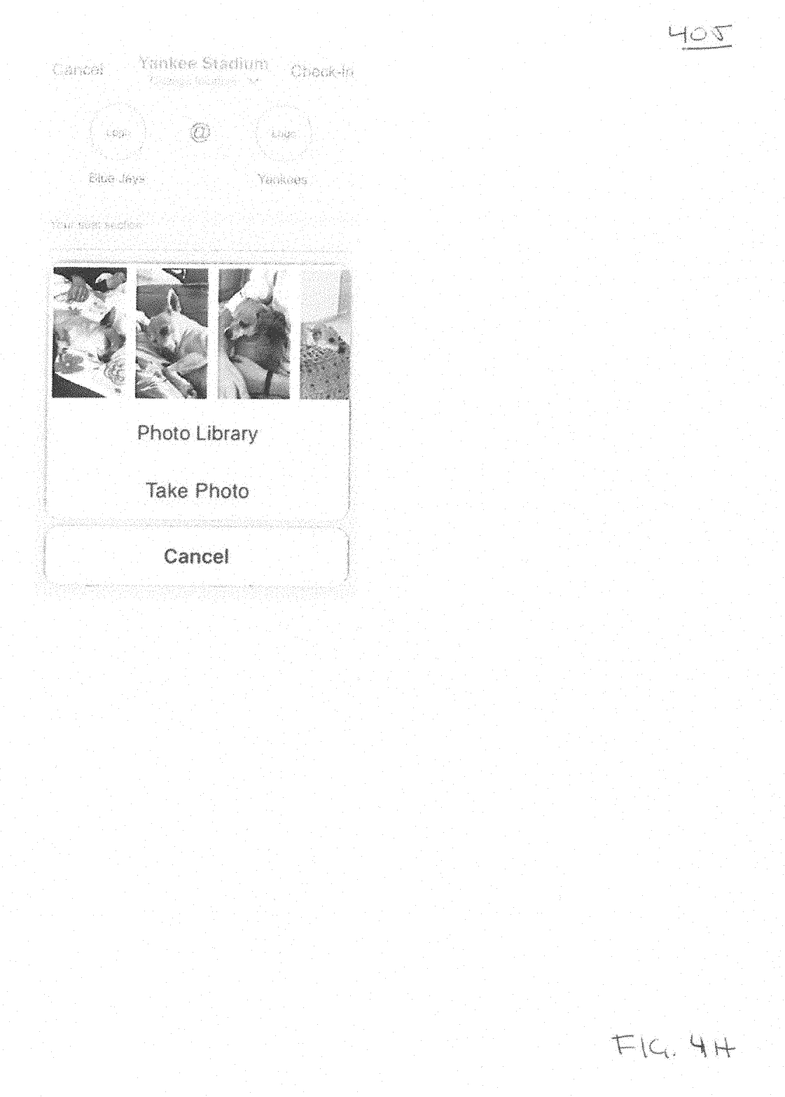

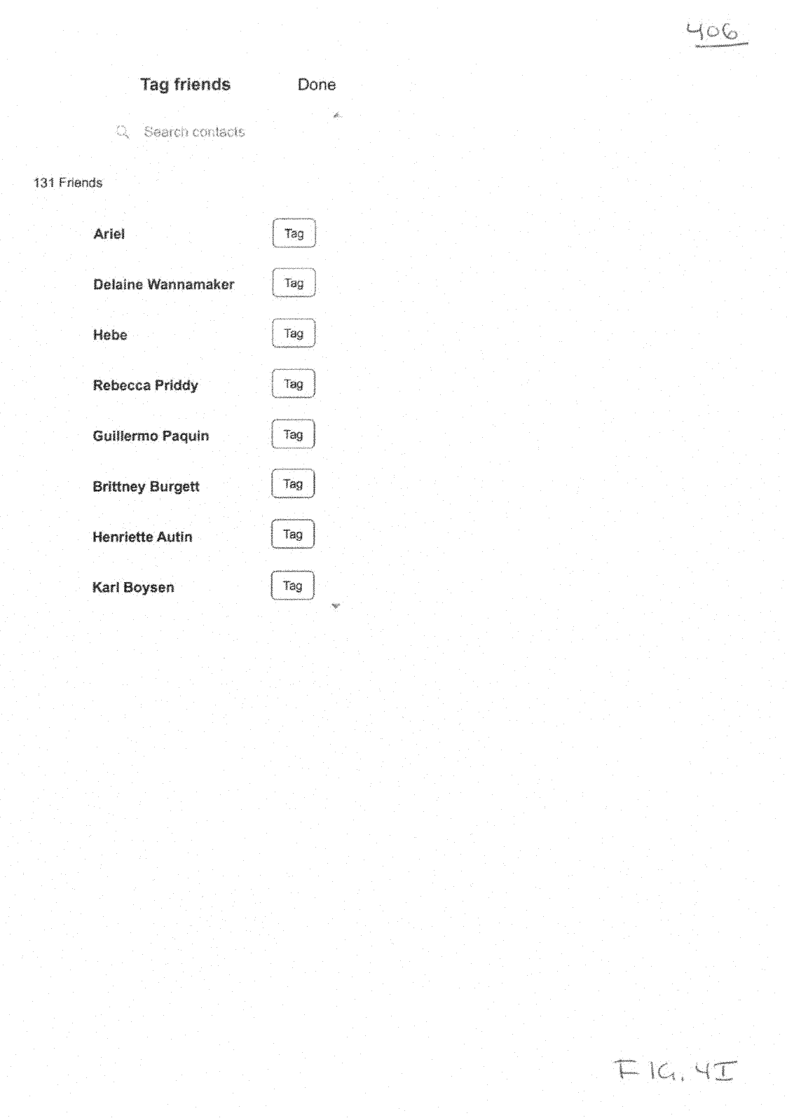

FIGS. 4A-4I present a flow diagram and example display screens illustrating a methods in accordance with aspects of the present disclosure for a user to check in to the electronic scrapbook application with regard to a current event. For example, as shown in the flow diagram of FIG. 4A, when the user has signed in and is viewing the update screen 310 illustrated in FIG. 3L, he or she may select a current event (for example, a game between the Mets and Phillies) and be presented with a select location screen 401 (also illustrated in FIG. 4B) which will ask the user to indicate where he or she is located. As illustrated in FIG. 4B, the electronic scrapbook application may engage another location function of the mobile device 100 (for example, the GPS unit 108) to assist in providing a listing of potential locations that the user may select.

If the user selects one of the identified location as a stadium (for example, Citi Field), the application may present the user with a new check-in screen 402 (also illustrated in FIG. 4C) which identifies the event and location, and further provides the user with an opportunity to identify his or her seat section or row (or, alternatively, engage the camera unit 104 of the mobile device 100 to input this information by scanning an associated ticket barcode). New check-in screen 402 also provides the user with the ability to create an associated memento of the event, for example, by recording thoughts about the game via a text entry, adding media (for example, photos taken using the camera unit 104 or from other sources), and the ability to tag a friend via the electronic scrapbook application or via another social media application (for example, FACEBOOK). Alternatively, if the user selects a location that is not a seated venue for the event (for example, a pub where the event will be viewed on television), the user may be presented with a new check-in screen 403 (also illustrated in FIG. 4D) that omits a query regarding an associated seat location.

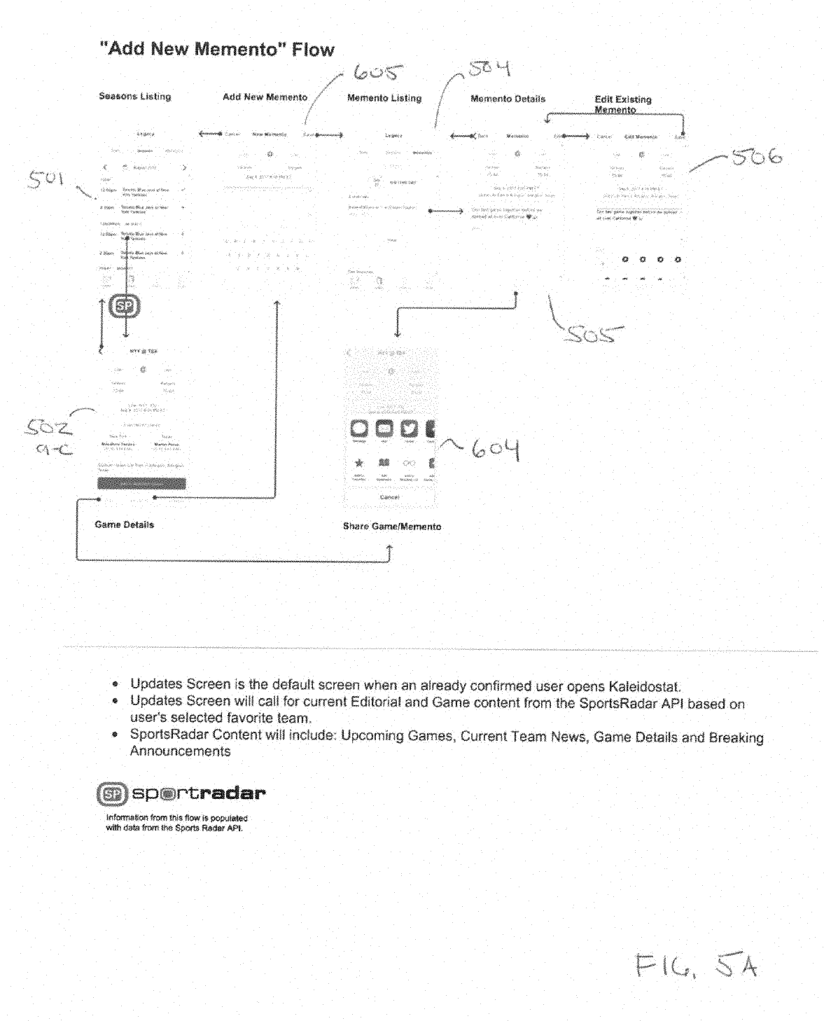

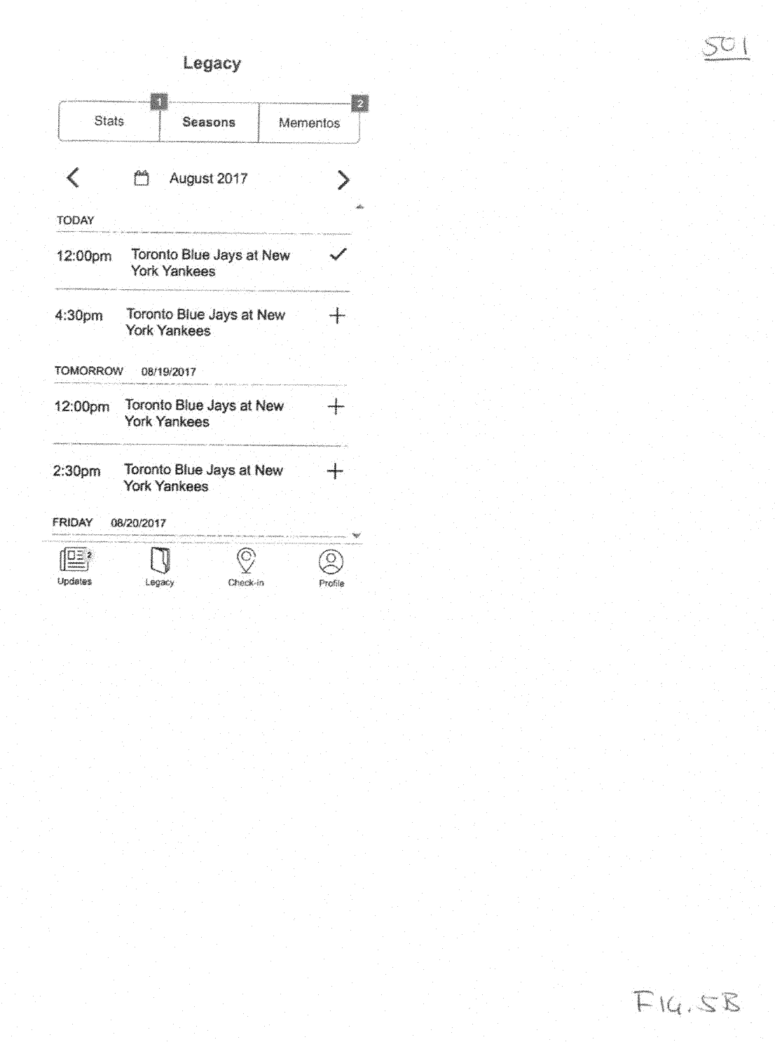

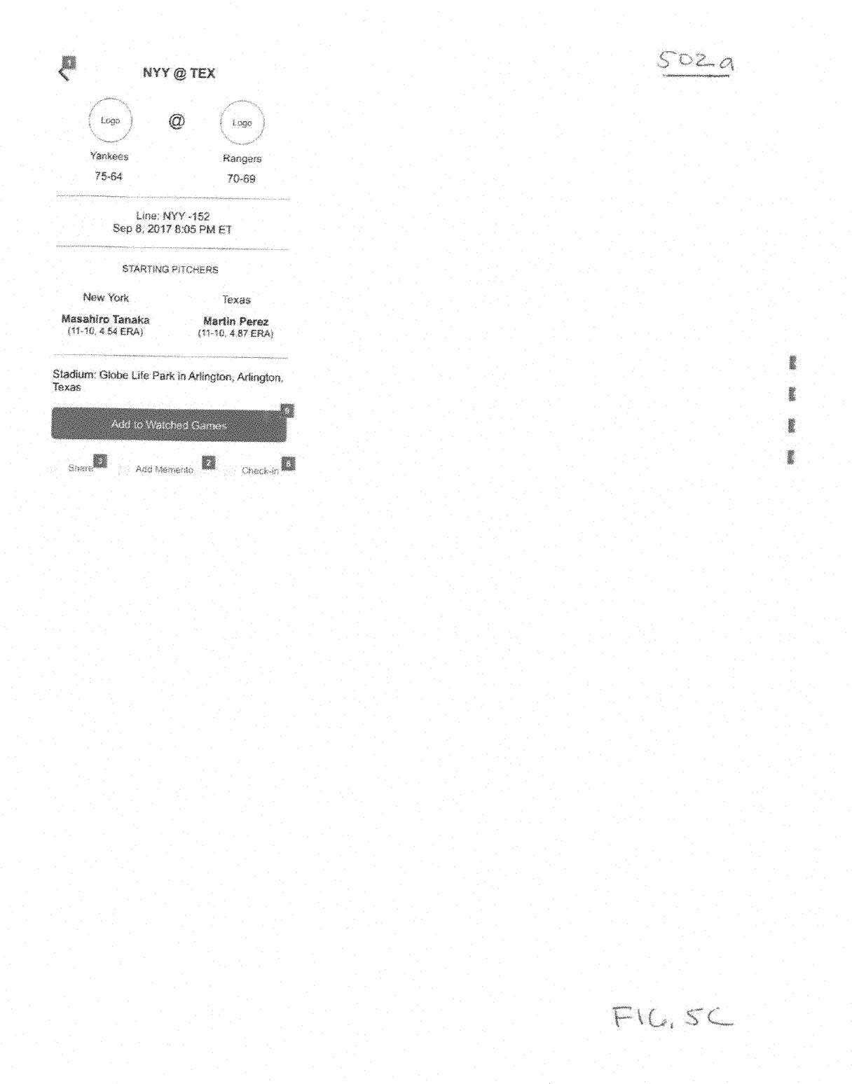

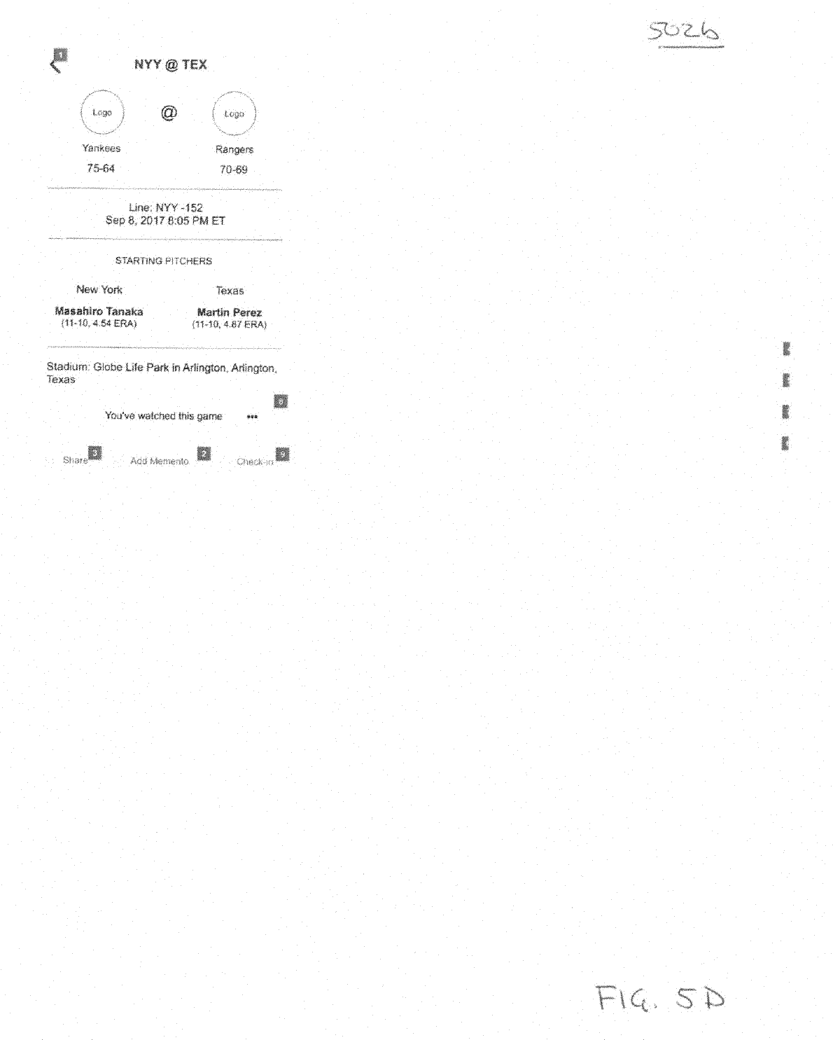

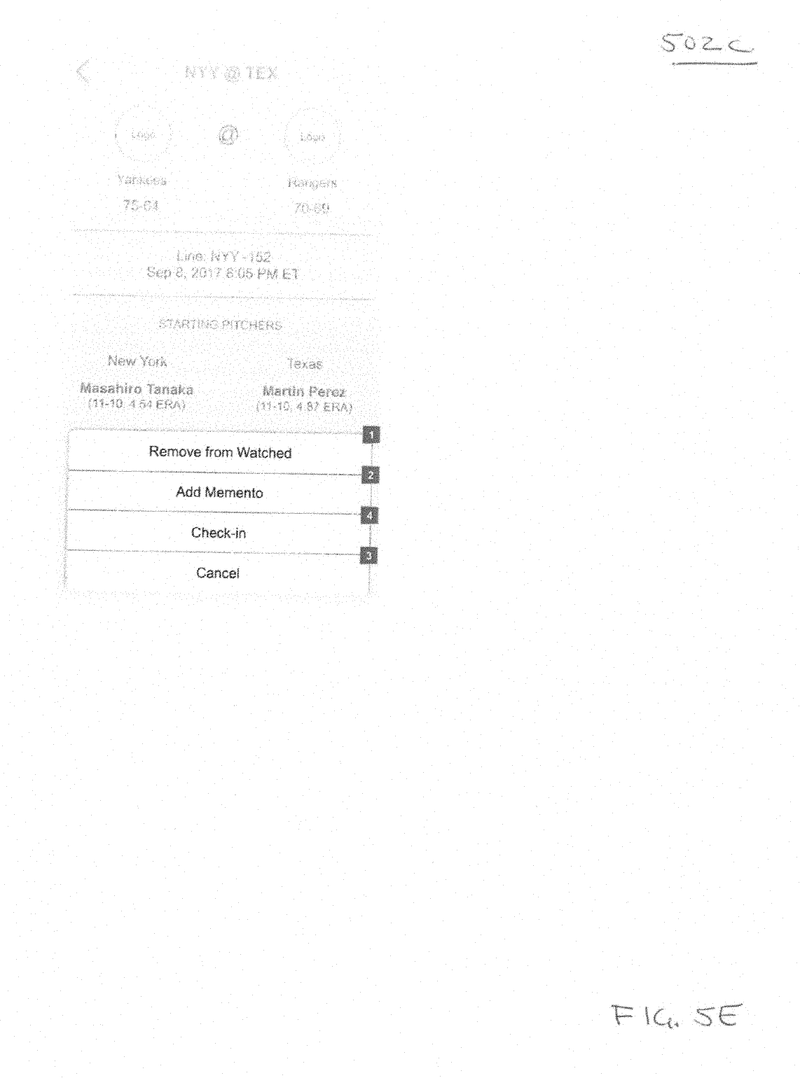

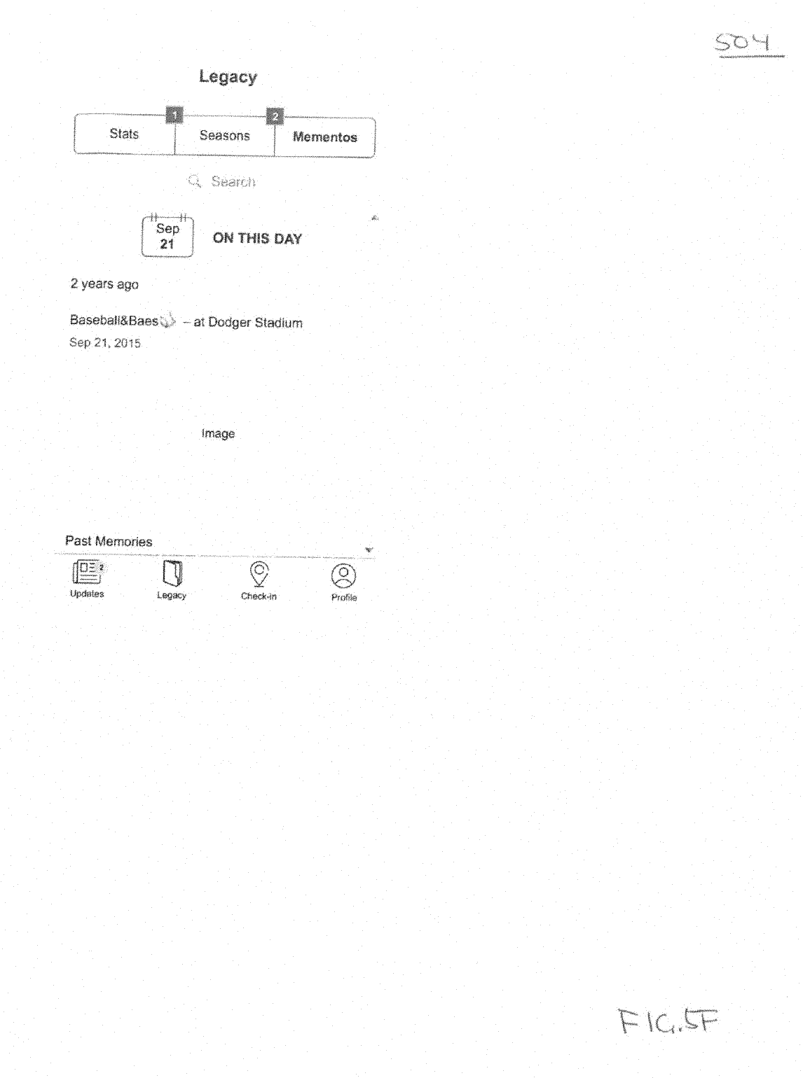

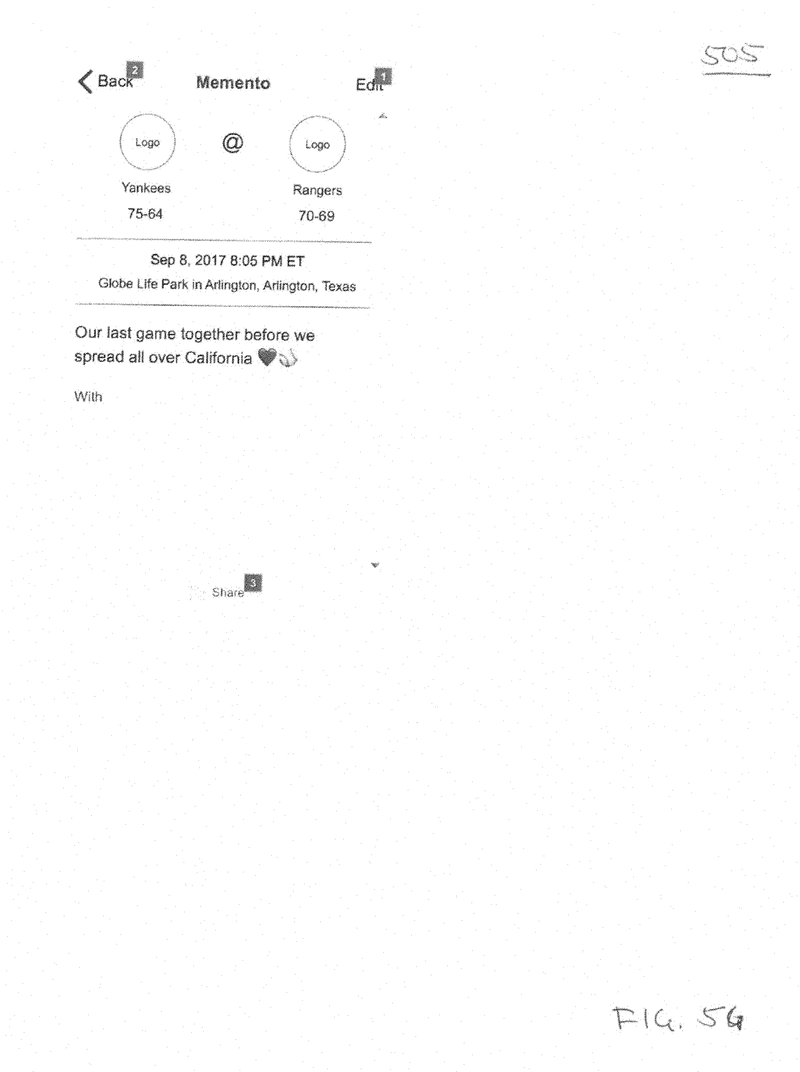

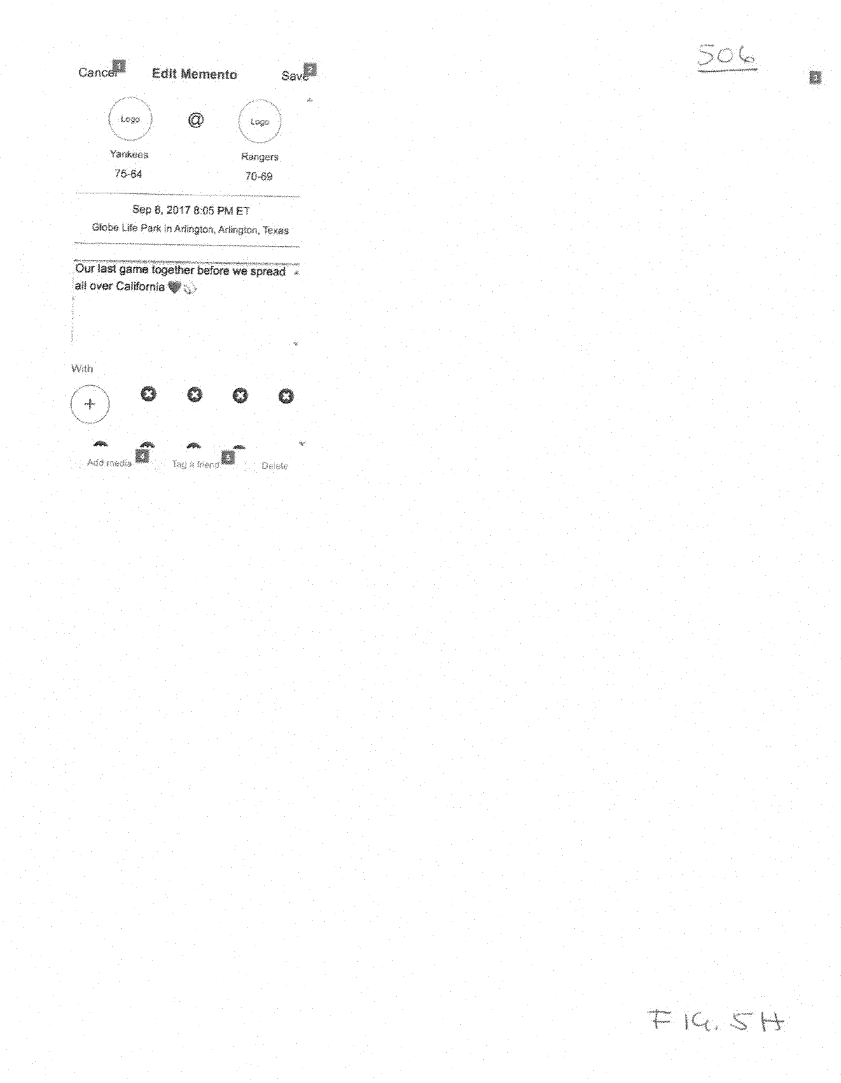

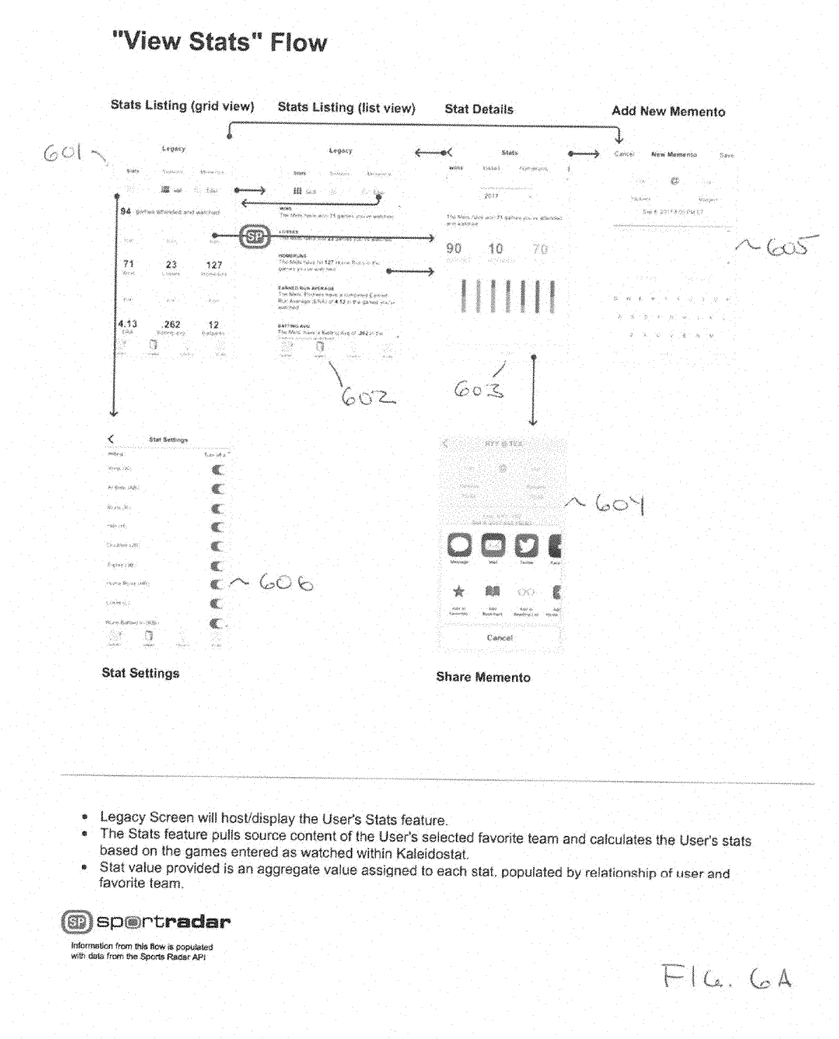

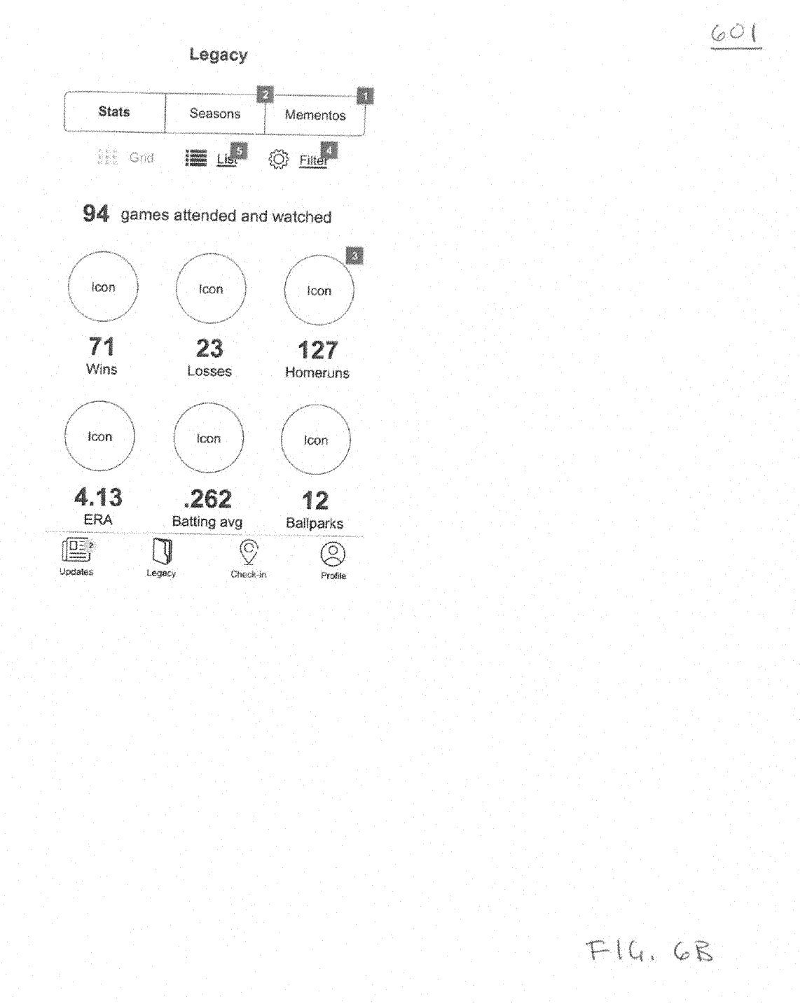

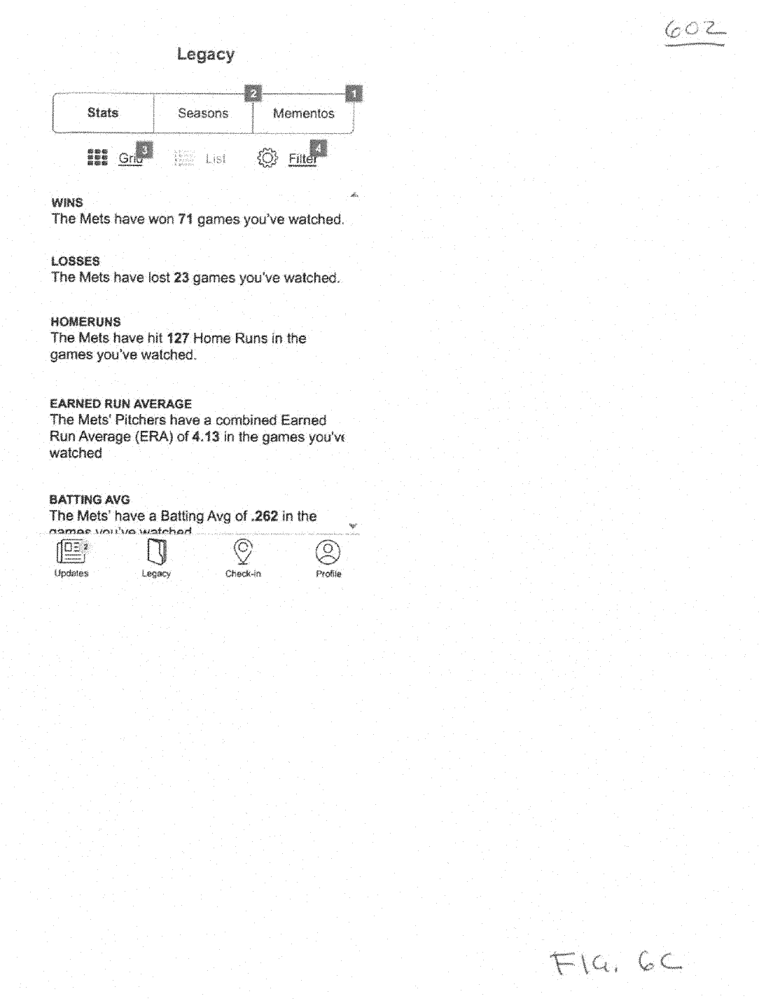

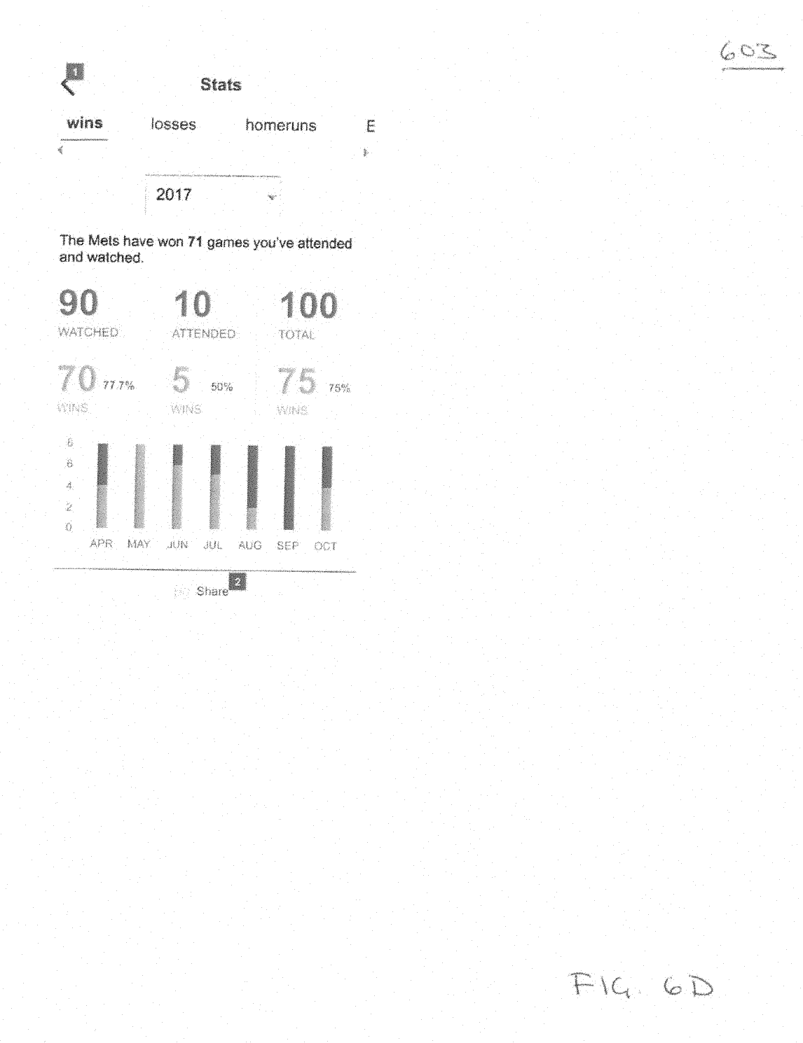

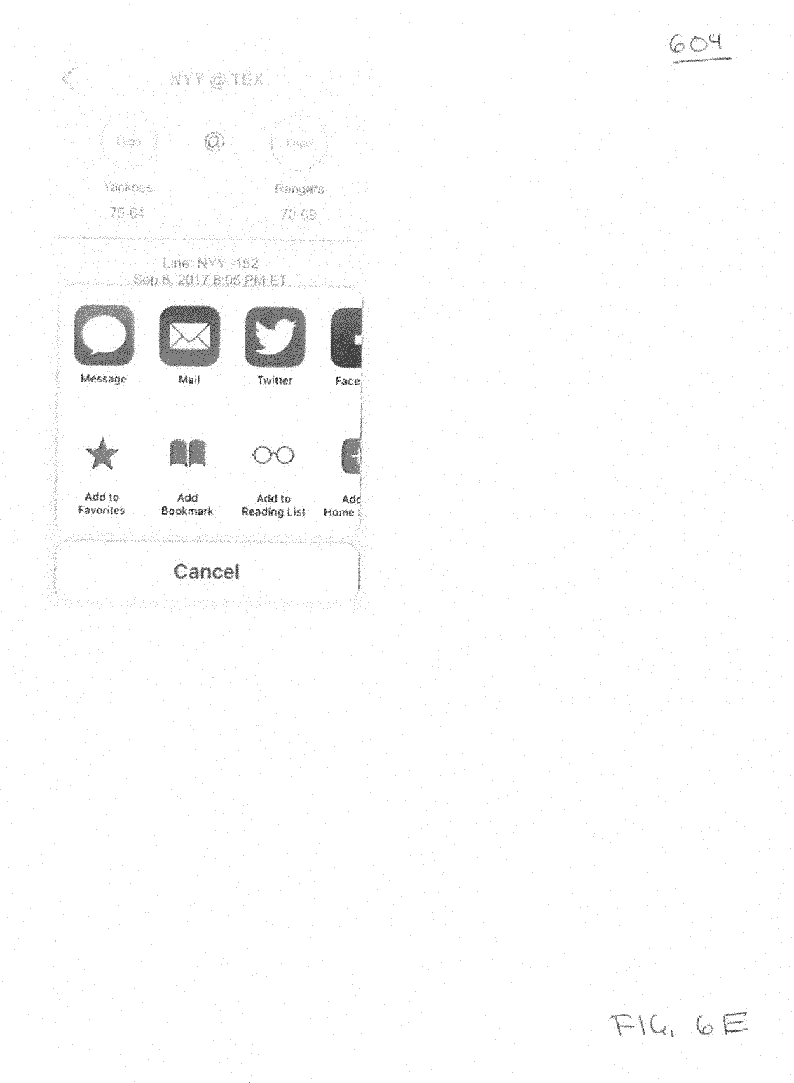

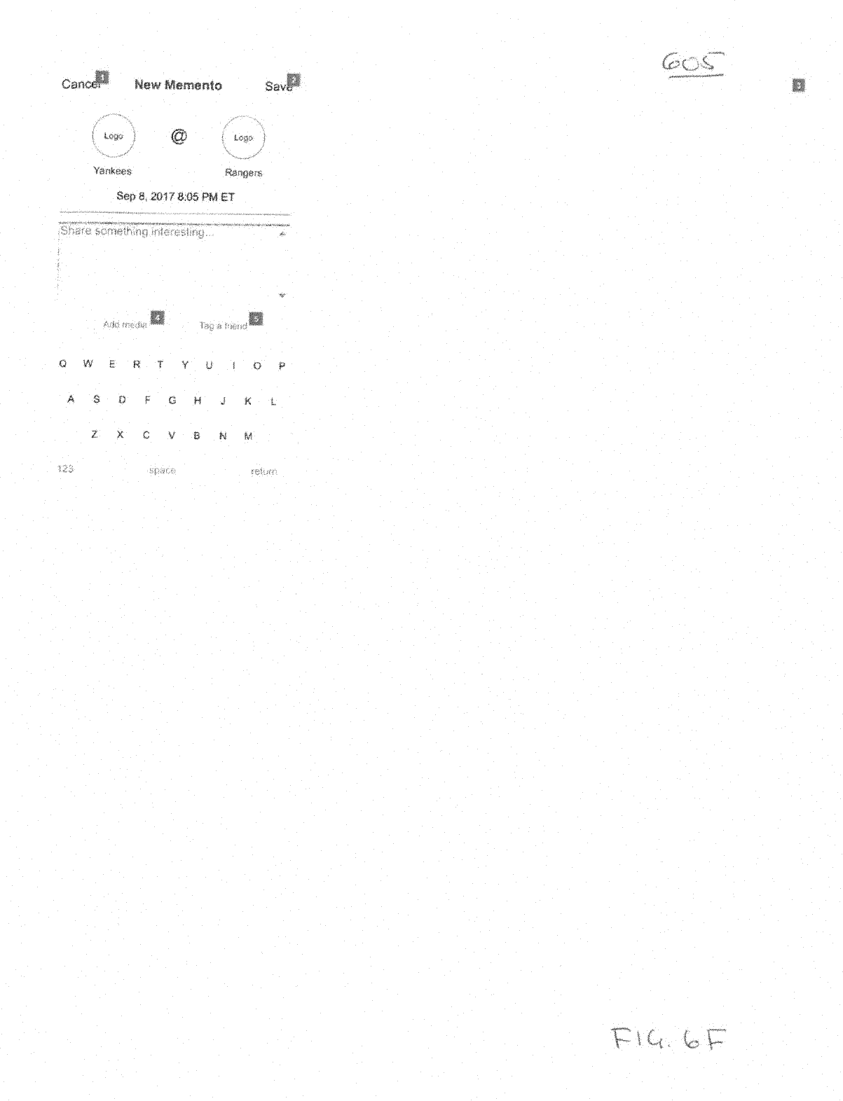

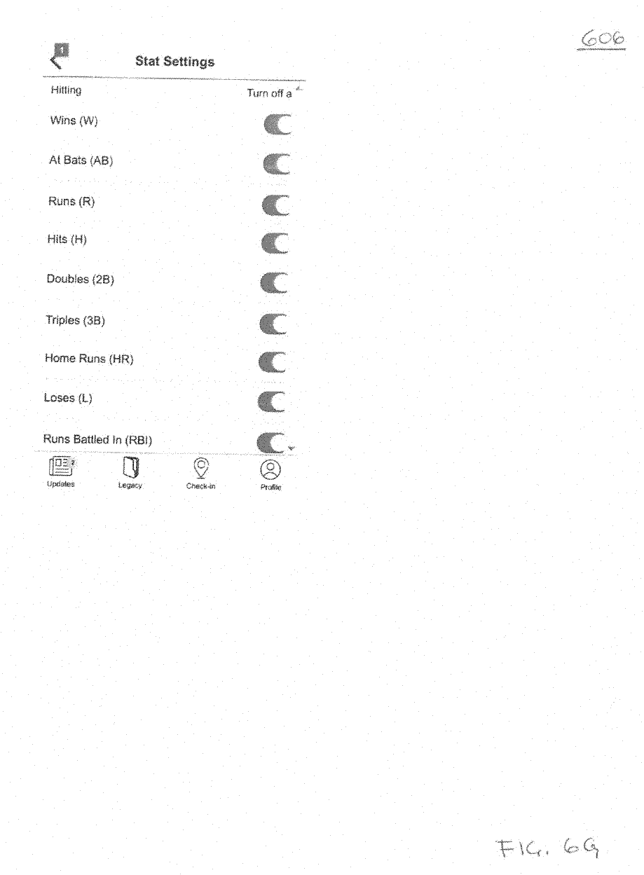

If the user elects to create an associated memento, a memento details screen 505 (also illustrated in FIGS. 5A, 5G) may be presented to the user that preferably identifies the current event; the date, time and location of the event, and other associated information (for example, for a baseball game, the current win/loss record of each team playing). The screen 505 may also present current memento details (for example, text entries and friends tagged), and invite the user to share the memento more extensively. If the user chooses to further share the memento, a share memento screen 604 may be presented (also illustrated in FIGS. 6A, 6E) to provide a variety of sharing options (for example, via native text messaging and e-mail applications of the mobile device, or via third-party social media applications including TWITTER and FACEBOOK). The screen 505 may also enable the user to elect to edit the current memento, causing the electronic scrapbook application to present an edit memento screen 506 (also illustrated in FIGS. 5A, 5H), for example by adding media via add media screen 405 (also illustrated in FIG. 4H or tagging additional friends via tag friends screen 406 (also illustrated in FIG. 4I). Tag friends screen 406, for example, may present the user with a list of contacts stored in a contacts application of the mobile device 100 who have been previously tagged.

If the user seeks to tag a new friend for the first time, he or she may preferably be presented with friends screens 404a-c (also illustrated in FIGS. 4E-4G). Screen 404a, for example, may invite the user to attach one or more social media application profiles (for example, from FACEBOOK or TWITTER), or alternatively import additional contacts from the contacts application of the mobile device 100. The user, for example, may proceed to sign in to FACEBOOK via the FACEBOOK sign-in screen 303 (also illustrated in FIGS. 3A, 3D) to import FACEBOOK contacts, or import contacts from the contacts application of the mobile device via the import contacts screen 407. If the user has not enabled the mobile device 100 to provide contacts from the contacts application for use by the electronic scrapbook application, the user may be presented with an import contacts error screen 408 that enable the user to proceed to a device settings screen 409 in order to enable contact access.

In addition or alternatively to the friends screen 404a, the electronic scrapbook application may present a discover people screen 404b that further identities contacts according to various characteristics (for example, contacts who currently use the electronic scrapbook application and are also FACEBOOK friends, electronic scrapbook application users who share the same favorite team as the user, and the like), and enables the user to send follow requests to these contacts. In addition or alternatively, the user may be presented with a friends screen 404c that identifies contacts and/or social media friends of the user, and enable the user to invite these contacts and friends to become users of the electronic scrapbook application.

FIGS. 5A-5H present a flow diagram and example display screens providing some additional detail concerning methods for adding a memento in association with an event in the electronic scrapbook application in accordance with aspects of the present disclosure. For example, as shown in FIG. 5A, past current and future events of interest to the user (for example, including games played by the user's favorite team) may be identified to the user by date and time on a legacy screen 501 (also illustrated in FIG. 5B). Once an event is selected by the user, an event details screen 502a (also illustrated in FIG. 5C) may be presented to the user. For the example of an MLB game, the event details screen 502a may identify the teams playing the date, time and location of the game, and other associated information (example, the teams' win/loss records, the venue, the starting pitchers and associates pitching statistics). The game information and associated statistics may be gathered in real-time from a third-party data source, and/or from information stored by the electronic scrapbook application (particularly for past games attended or watched by the user. The user may indicate that he or she is attending or watching the game, and may also add a memento or tag users for sharing as described above with reference to FIGS. 4A-4I. As illustrated for example with reference to FIG. 5D, an event details screen 502b may alternatively be presented to the user if the selected game is a game that has already been attended or watched by the user. If already watched, as illustrated in FIG. 5E, the user may further be presented with event edit screen 502c to edit the current event record (for example, to add a new memento, or remove the game from the user's record of watched games.

In the case of a new memento, as shown in FIG. 5A, the user may be presented with an add new memento screen (also illustrated by FIGS. 6A, 6F) which, as illustrated, enable the user to add a text-based memento (for example, “caught my first foul ball at this game). Once entered, the user may access the memento, for example, from legacy screen 504 (also illustrated in FIG. 5F), and edit the memento by selecting the “edit” button on memento details screen 505 (also illustrated in FIG. 5G) to receive edit memento screen 506 (also illustrated in FIG. 5H). In addition, the new memento can be shared from memento details screen 505 by selecting the “share” button to receive share memento screen 604 (as further illustrated in FIGS. 6A, 6E).

FIGS. 6A-4G present a flow diagram and example display screens illustrating a methods for viewing user-specified statistics for events that the user has check into in the electronic scrapbook application in accordance with aspects of the present disclosure. As shown in FIG. 6A, stat listing screen 601 (further illustrated in FIG. 6B) provides a “memento” button that the user may select to retrieve summary statistics for all events the user has attended and/or watched. For example, as shown in FIG. 6B, statistics are provided for the total number of MLB games that the user has attended or watched, and among those games, the total numbers that have been won and lost by the user's favorite team, the total number of homeruns that have been hit by the user's favorite team, the overall pitching earned run average (ERA) for the user's favorite team, the batting average for the user's favorite team, and the number of ballparks visited by the user's favorite team. The underlying data for computing these statistics are preferably retrieved by the electronic scrapbook application accessing data held by third-party data providers (for example, SPORTRADAR for data concerning MLB games), as described above, for example, with reference to FIG. 2. The electronic scrapbook application may preferably provide the statistical data to the user in several formats. For example, statistics presented on stat listing screen 601 are shown in a so-called “grid format,” accessible by selecting a “grid” button as shown on stat listing screen 601. Alternatively, as shown on stat listing screen 602 (also illustrated in FIG. 6C), a “list” button can be selected to present these statistics in a list format.

As shown in FIG. 6C, stat listing screen 602 further provides “filter” button to select and present statistics based on a subset of the data. For example, as illustrated in FIG. 6A by stat details screen 603 (also illustrated in FIG. 6D), statistics can be limited and calculated, for example, only for games attended or watched in a particular year (for example, “2017”). Statistics are presented by stat details screen 603, for example, both in grid and histogram formats. In addition, stat details screen preferably includes a “share” button enabling the user to reach a share memento screen 604 (also illustrated in FIG. 6E) that may provide a variety of sharing options (for example, via native text messaging and e-mail applications of the mobile device, or via third-party social media applications including TWITTER and FACEBOOK).

Stat details screen 603 may in addition be operated to provide only selected statistics of interest to the user. For example, as shown in FIG. 6D, win statistics only have been selected for display. Returning to FIG. 6A, add new memento screen 605 may be invoked from one or more of screens 601, 602 and 603 to incorporate statistics in a new memento.

As further illustrated in FIG. 6A, the user may select to calculate and track a selected number of statistics of interest by means of a stat settings screen (also illustrated in FIG. 6G).

### REFERENCE CHARACTER TABLE

The following table lists the reference characters and names of features and elements used herein:

| | Feature or element |
|---|---|
| 100 | Mobile Device |
| 101 | Processor |
| 102 | Operating System (OS) |
| 103 | Memory (Mem) |
| 104 | Camera Unit |
| 105 | Software Applications (App1, App2, App3) |
| 106 | Network Interfaces (Comm 1, Comm 2) |
| 107 | Display (DP) |
| 108 | GPS Unit |
| 201 | Ingress Module |
| 202 | Profile Module |
| 203 | Event Data Module |
| 204 | Access Module |
| 205 | Database |
| 206 | Data Cache |
| 207 | Authentication Module |
| 208 | Third Party Provider |
| 209 | Event Database |
| 210 | Event Data Provider Interface |
| 211 | Event Data Provider |

It will be understood that, while various aspects of the present disclosure have been illustrated and described by way of example, the invention claimed herein is not limited thereto, but may be otherwise variously embodied within the scope of the following claims. For example, it should be understood that while the principle example provided is directed to electronic scrapbooking for sporting events such as MLB baseball games, the disclosed system and methods are equally applicable to many other event-driven applications, for example including concerts, vacation venues, food venues and bars, national parks, and the like.

I claim:

1. A computer-implemented method for updating user-defined statistics in an electronic scrapbook on a mobile device, the user-defined statistics associated with events of a predetermined type to which the user has checked in, the method comprising the steps of:
receiving an input signal at user interface of the mobile device, the input signal signaling a user check-in for a current event of the predetermined type;
identifying user-defined statistics and associated attributes for events of the predetermined type;
identifying past events of the predetermined type for which the user previously checked in;
displaying values of the user-defined statistics for the past events on a display screen of the mobile device;
identifying one or more network-accessible data sources for retrieving information relating to the associated attributes for the user-defined statistics;
retrieving information relating to the associated attributes for at least the current event from the one or more data sources over one or more data networks;
calculating updated user-defined statistics for both the past and current events based on at least the retrieved information; and
displaying values of the updated statistics on the display screen of the mobile device,
whereby the updated user-specified statistics displayed on the display screen of the mobile device are expressed with respect only to events of the predetermined type to which the user has checked in.

2. The method of claim 1, wherein the predetermined event type is a sporting event.

3. The method of claim 2, further comprising the step of receiving an input at the user interface of the mobile device identifying a favorite team of the user.

4. The method of claim 3, further comprising the step of displaying a listing of current events on the display screen of the mobile device that includes at least one event including the favorite team.

5. The method of claim 2, wherein the predetermined event type is a baseball game.

6. The method of claim 5, wherein the user-defined statistics include one or more statistics selected from the group consisting of wins, losses, at bats, runs, hits, doubles, triples, home runs, runs batted in, batting average, walks, strikeouts, stolen bases and attempts caught stealing.

7. The method of claim 5, wherein the user-defined statistics include one or more statistics selected from the group consisting of earned run average, saves, complete games, shutouts, walks and hits per inning pitched, strike outs per walk, strike outs per 9 innings, earned runs, runs, strike outs, walks against, stolen bases against and wild pitches.

8. The method of claim 1, further comprising the step of receiving an input signal at the user interface identifying a location of the user for the current event.

9. The method of claim 8, wherein the step of the step of receiving an input signal identifying a location of the user includes the step of displaying a list of available locations on the display screen of the mobile device.

10. The method of claim 1, further comprising the step of receiving an input signal at the user interface associating a media file with the current event.

11. The method of claim 10, wherein the media file comprises a photo file stored in a photo library of the mobile device.

12. The method of claim 1, further comprising the step of receiving an input signal for identifying one or more friends of the user to be tagged with information about the event in a social media application.

13. The method of claim 12, wherein the step of identifying the one or more friends includes the step of displaying a list of friends on the display screen of the mobile device.

14. The method of claim 1, further comprising the steps of creating one or more mementos records associated with the current event.

15. The method of claim 14, wherein the one or more memento records include a time stamp.

16. The method of claim 14, further comprising the step of associating a media file with the one memento record.

17. The method of claim 14, further comprising the step of identifying one or more friends of the user to be tagged with information from the memento record in a social media application.

18. A mobile device configured to provide an electronic scrapbook application operable for updating user-defined statistics for a current event of a predetermined type, the mobile device comprising:
a processor,
an operating system responsive to an application program comprising the electronic scrapbook application;
a memory accessible by the processor,
a user interface comprising a touch screen display; and
at least one network interface,
wherein the mobile device is configured to:
received an input signal at the touch screen display, the input signal signaling a user check-in to the current event of the predetermined type;
identifying the user-defined statistics and associated attributes for events of the predetermined type;
identifying past events of the predetermined type for which the user previously checked in;
displaying values of the user-defined statistics for the past events on a display screen of the mobile device;
identifying one or more network-accessible data sources for retrieving information relating to the associated attributes for the user-defined statistics;
retrieving information relating to the associated attributes for at least the current event from the one or more data sources via the network interface;
calculating updated user-defined statistics for both the past and current events based on at least the retrieved information; and
displaying values of the updated statistics on the touch screen display,
whereby the updated user-specified statistics displayed on the display screen of the mobile device are expressed with respect only to events of the predetermined type to which the user has checked in.
